(19) United States
(12) Patent Application Publication
(10) Pub. No.: US 2013/0176743 A1
(43) Pub. Date: Jul. 11, 2013

(54) LUMINAIRE MOUNTING INTERFACE

(71) Applicant: SYLVAN R. SHEMITZ DESIGNS INCORPORATED, West Haven, CT (US)

(72) Inventors: David R. Pfund, Woodbridge, CT (US); Matthew R. Bullard, Unionville, CT (US)

(73) Assignee: SYLVAN R. SHEMITZ DESIGNS INCORPORATED, West Haven, CT (US)

(21) Appl. No.: 13/739,838

(22) Filed: Jan. 11, 2013

Related U.S. Application Data
(60) Provisional application No. 61/585,478, filed on Jan. 11, 2012.

(51) Int. Cl. F21V 21/00

(52) U.S. Cl. CPC F21V 21/00
USPC 362/368; 362/382

(57) ABSTRACT

Disclosed is a luminaire mounting interface including an interface body configured for association with a luminaire, and an interface surface of the interface body, the interface surface including at least two association points separated by 75 mm to 142 mm.

### CROSS-REFERENCE TO RELATED APPLICATIONS

This application is related to and claims the benefit of U.S. Provisional Patent Application Ser. No. 61/585,478 filed on Jan. 11, 2012, the entire contents of which are herein incorporated by reference.

### FIELD

The disclosure generally relates to a luminaire mounting system, and more particularly to a luminaire mounting system for use with a support.

### BACKGROUND

Adjustable support devices such as “monitor supports” or “monitor stands” are widely available for use in office environments. In practice, these devices are often associated with office workstations in a manner that advantageously positions workstation resources, such as visual display terminals (VDTs), so as to maximize operator comfort and/or productivity. Similarly, it is common in the art to use positionable luminaires that deliver task and/or ambient lighting in and around these workstations and VDTs in a manner that enhances the overall well-being and productivity of a workstation occupant.

However, the proliferation of adjustable systems and devices associated with workstations can lead to complex workstation component inventories and visual clutter. It is therefore desirable and advantageous to provide luminaires and luminaire mounting interfaces that allow workstation lighting to be deployed on and across a wide range of the known adjustable support apparatus used for positioning VDTs and other workstation resources relative to office workstations and the occupants thereof.

### SUMMARY

Disclosed is a luminaire mounting interface including an interface body configured for association with a luminaire, and an interface surface of the interface body, the interface surface including at least two association points separated by 75 mm to 142 mm.

Also disclosed is a luminaire including a luminaire housing, an interface body extending from the luminaire housing, and an interface surface of the interface body, the interface surface including at least two association points separated by 75 mm to 142 mm.

Further disclosed is a luminaire mounting system including a luminaire with a luminaire housing, an interface body extending from the luminaire housing, an interface surface of the interface body, the interface surface including at least two association points separated by 75 mm to 142 mm, and a luminaire support including a support interface that is compatible with the interface and said at least two association points.

### BRIEF DESCRIPTION OF THE FIGURES

The foregoing and other features and advantages of the present invention should be more fully understood from the following detailed description of illustrative embodiments taken in conjuncture with the accompanying Figures in which like elements are numbered alike in the several Figures:

FIG. 1 is a perspective view of a luminaire with a mounting interface in accordance with an exemplary embodiment;

FIG. 2 is another perspective view of the luminaire of FIG. 1;

FIG. 3 is a cross-sectional view of the luminaire of FIG. 1;

FIG. 4 is a schematic view of a luminaire mounting system in accordance with an exemplary embodiment;

FIG. 5 is a top plan view of the luminaire of FIG. 1;

FIG. 6 is a front elevation view of the luminaire of FIG. 1;

FIG. 7 is a side elevation view of the luminaire of FIG. 1;

FIG. 7a is a side elevation view of the luminaire of FIG. 1 indicating planes thereof;

FIG. 8 is a bottom plan view of the luminaire of FIG. 1;

FIG. 9 is a back elevation view of the luminaire of FIG. 1;

FIG. 10 is a bottom plan view of an interface surface of the luminaire of FIG. 1;

FIG. 11 is a perspective view of a luminaire with a mounting interface in accordance with an exemplary embodiment;

FIG. 12 is another perspective view of the luminaire of FIG. 11;

FIG. 13 is a top plan view of the luminaire of FIG. 11;

FIG. 14 is a front elevation view of the luminaire of FIG. 11;

FIG. 15 is a side elevation view of the luminaire of FIG. 11;

FIG. 16 is a bottom plan view of the luminaire of FIG. 11;

FIG. 17 is a back elevation view of the luminaire of FIG. 11;

FIG. 18 is a bottom plan view of an interface surface of the luminaire of FIG. 11;

FIG. 19 is a perspective view of a luminaire with a mounting interface in accordance with an exemplary embodiment;

FIG. 20 is another perspective view of the luminaire of FIG. 19;

FIG. 21 is a top plan view of the luminaire of FIG. 19;

FIG. 22 is a front elevation view of the luminaire of FIG. 19;

FIG. 23 is a side elevation view of the luminaire of FIG. 19;

FIG. 24 is a bottom plan view of the luminaire of FIG. 19;

FIG. 25 is a back elevation view of the luminaire of FIG. 19;

FIG. 26 is a bottom plan view of an interface surface of the luminaire of FIG. 19;

FIG. 27 is a perspective view of a luminaire with a mounting interface in accordance with an exemplary embodiment;

FIG. 28 is another perspective view of the luminaire of FIG. 27;

FIG. 29 is a top plan view of the luminaire of FIG. 27;

FIG. 30 is a front elevation view of the luminaire of FIG. 27;

FIG. 31 is a side elevation view of the luminaire of FIG. 27;

FIG. 32 is a bottom plan view of the luminaire of FIG. 27;

FIG. 33 is a back elevation view of the luminaire of FIG. 27;

FIG. 34 is a bottom plan view of an interface surface of the luminaire of FIG. 27;

FIG. 35 is a perspective view of a luminaire with a mounting interface in accordance with an exemplary embodiment;

FIG. 36 is another perspective view of the luminaire of FIG. 35;

FIG. 37 is a top plan view of the luminaire of FIG. 35;

FIG. 38 is a front elevation view of the luminaire of FIG. 35;

FIG. 39 is a side elevation view of the luminaire of FIG. 35;

FIG. 40 is a bottom plan view of the luminaire of FIG. 35;

FIG. 41 is a back elevation view of the luminaire of FIG. 35;

FIG. 42 is a bottom plan view of an interface surface of the luminaire of FIG. 35;

FIG. 43 is a perspective view of a luminaire with a mounting interface in accordance with an exemplary embodiment;

FIG. 44 is another perspective view of the luminaire of FIG. 43;

FIG. 45 is a top plan view of the luminaire of FIG. 43;

FIG. 46 is a front elevation view of the luminaire of FIG. 43;

FIG. 47 is a side elevation view of the luminaire of FIG. 43;

FIG. 48 is a bottom plan view of the luminaire of FIG. 43;

FIG. 49 is a back elevation view of the luminaire of FIG. 43; and

FIG. 50 is a bottom plan view of an interface surface of the luminaire of FIG. 43.

### DETAILED DESCRIPTION

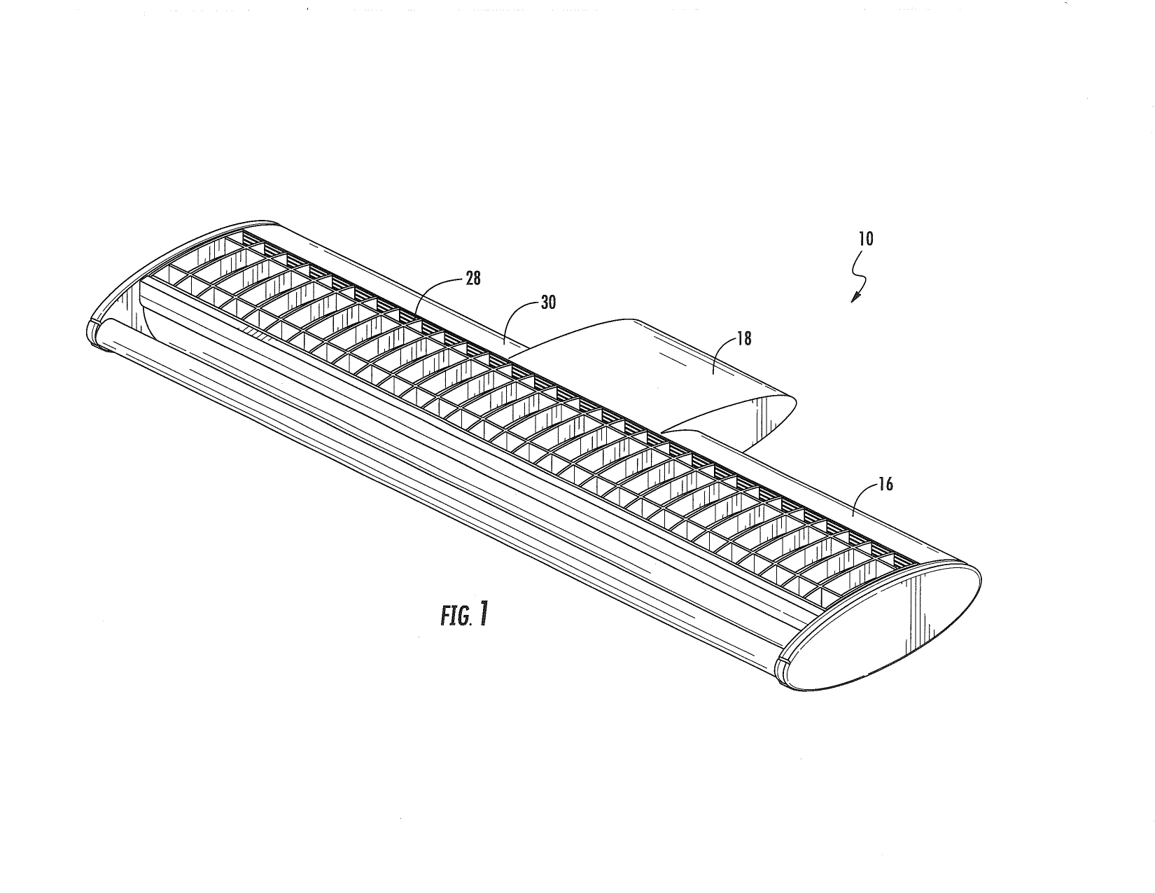

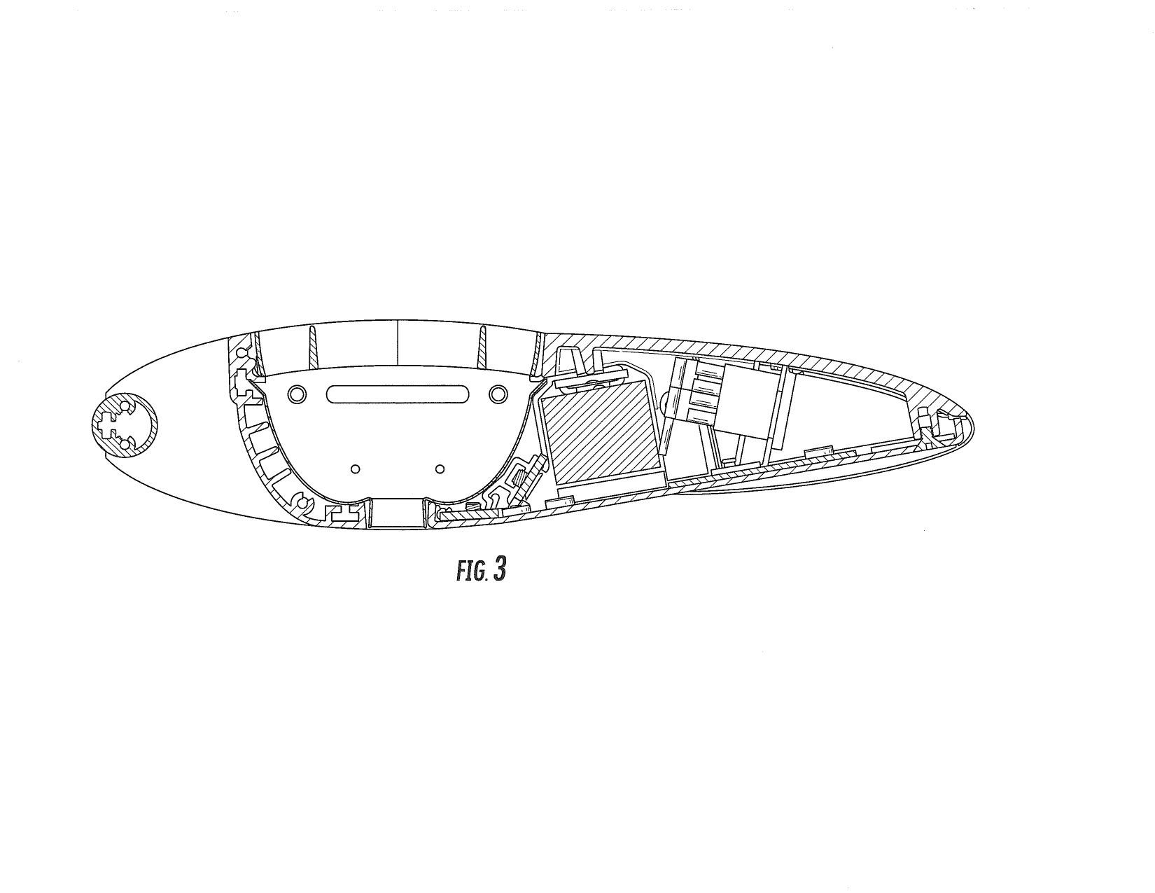

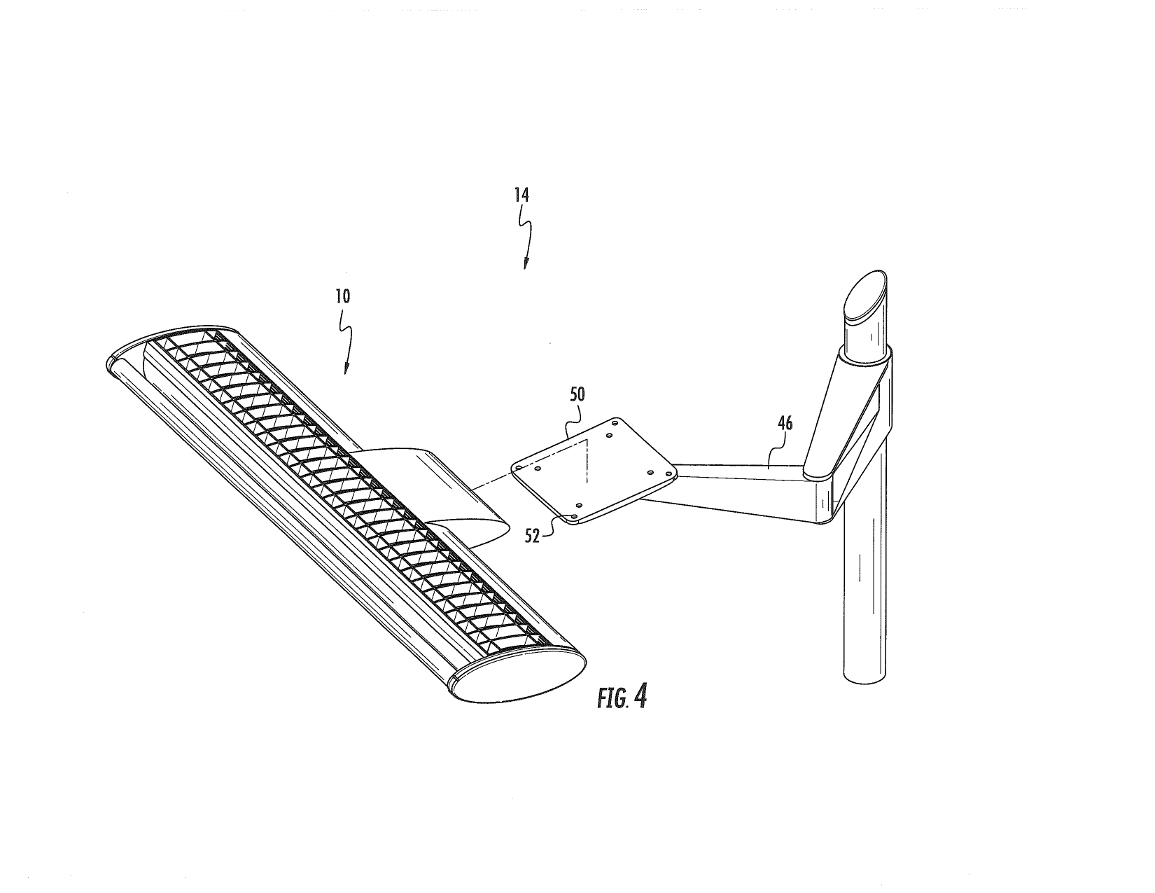

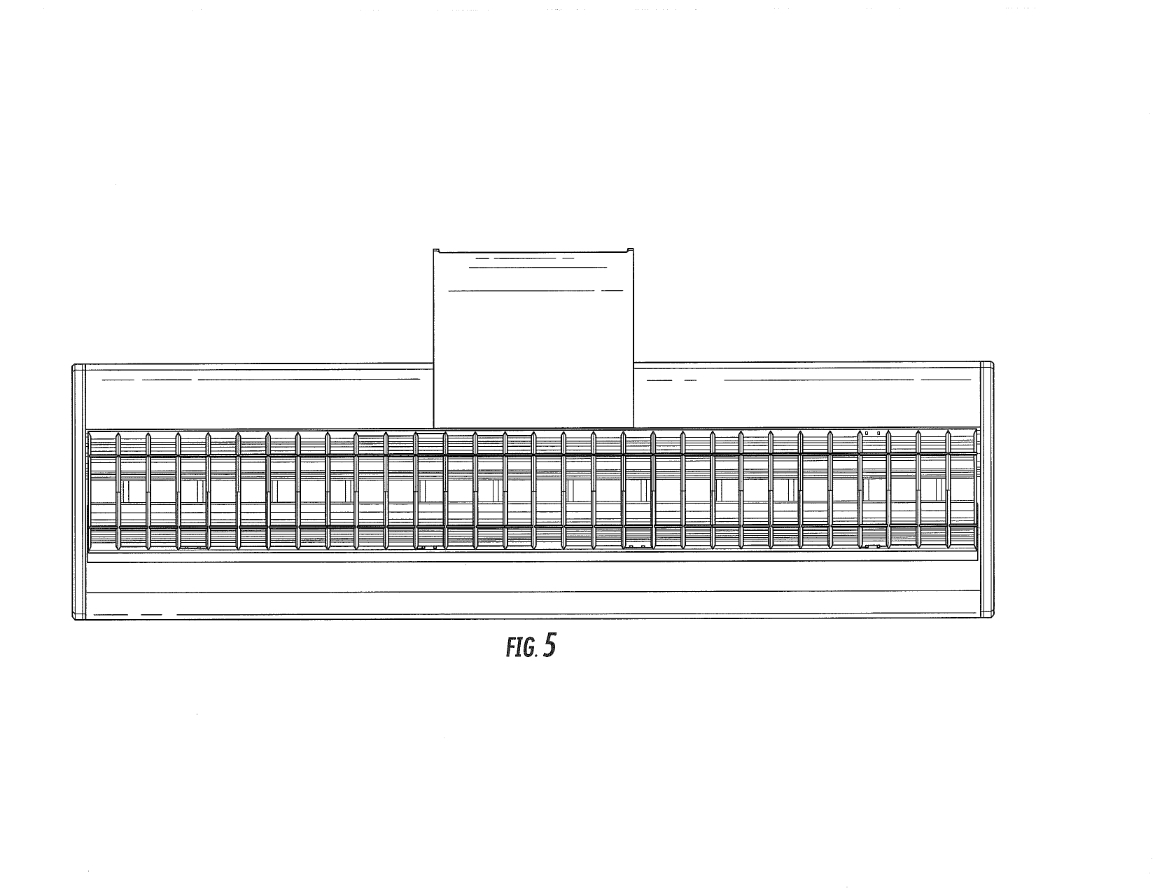

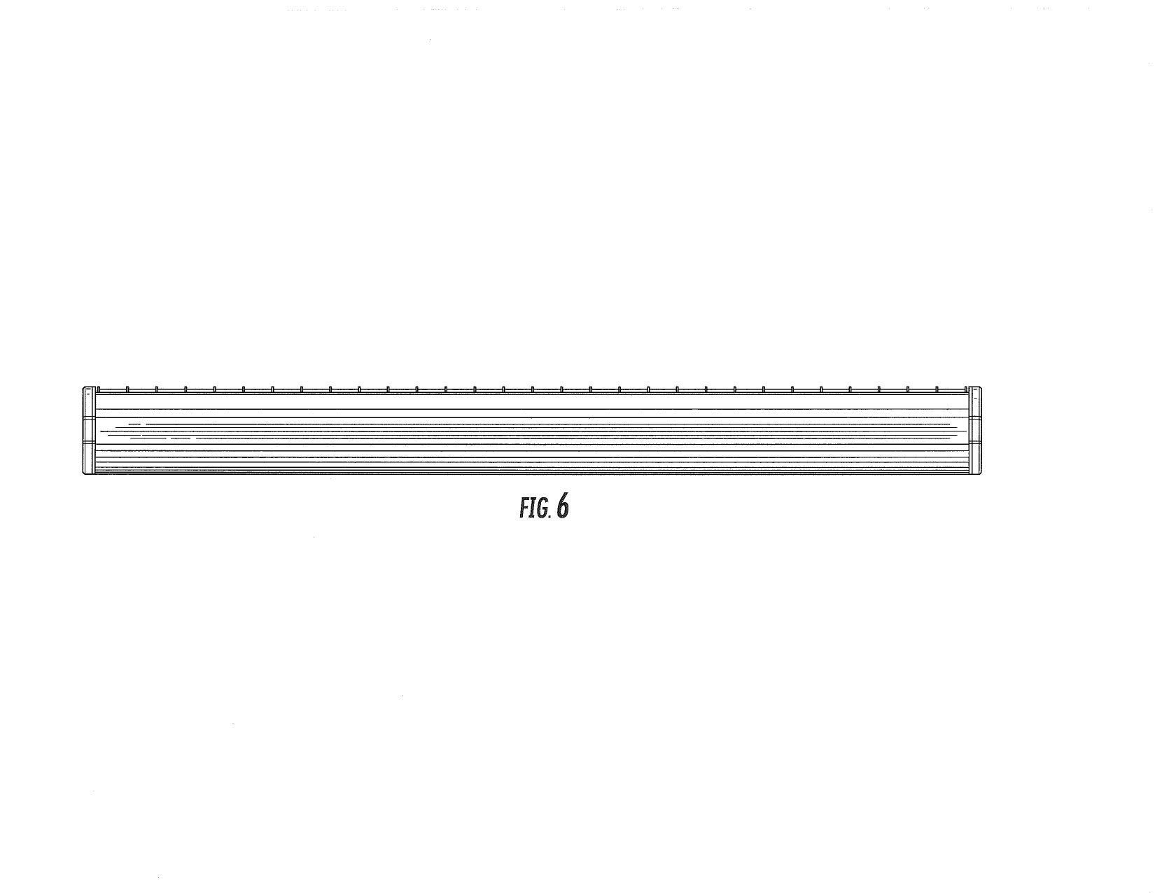

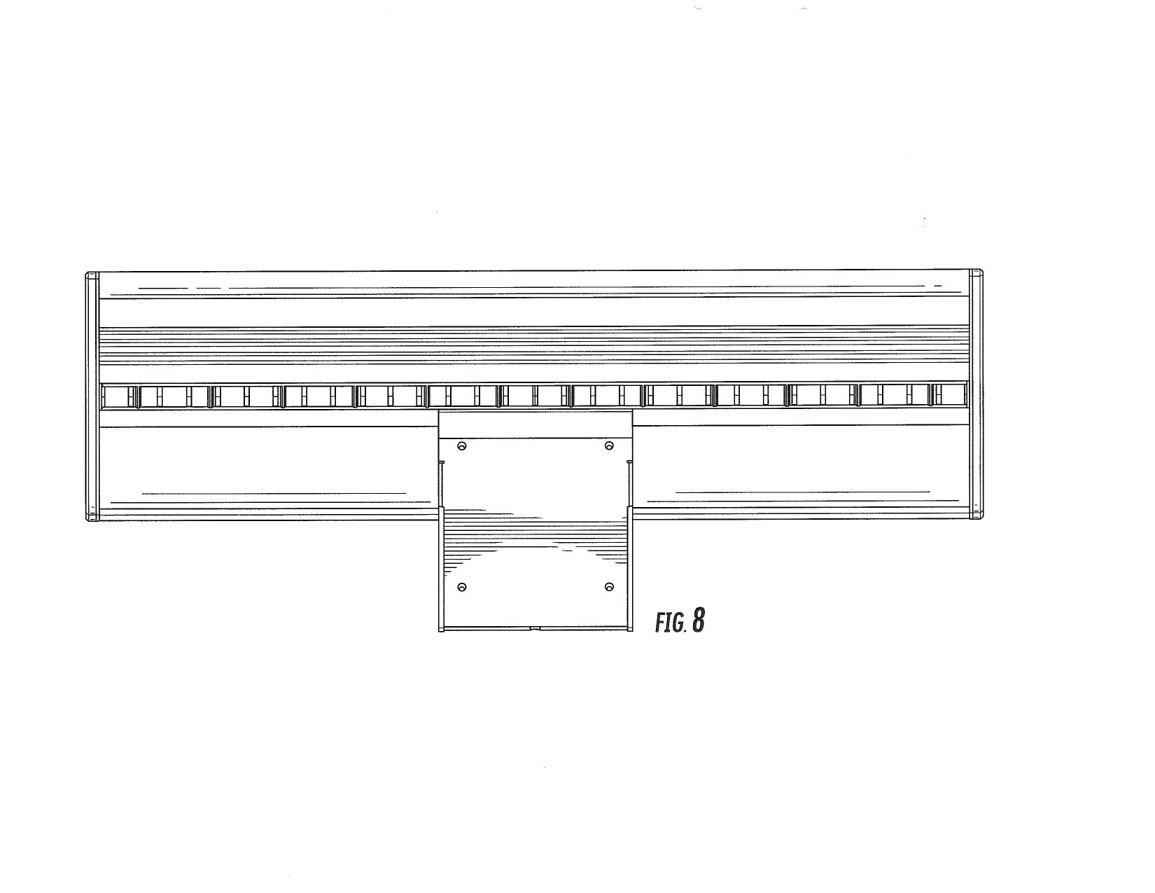

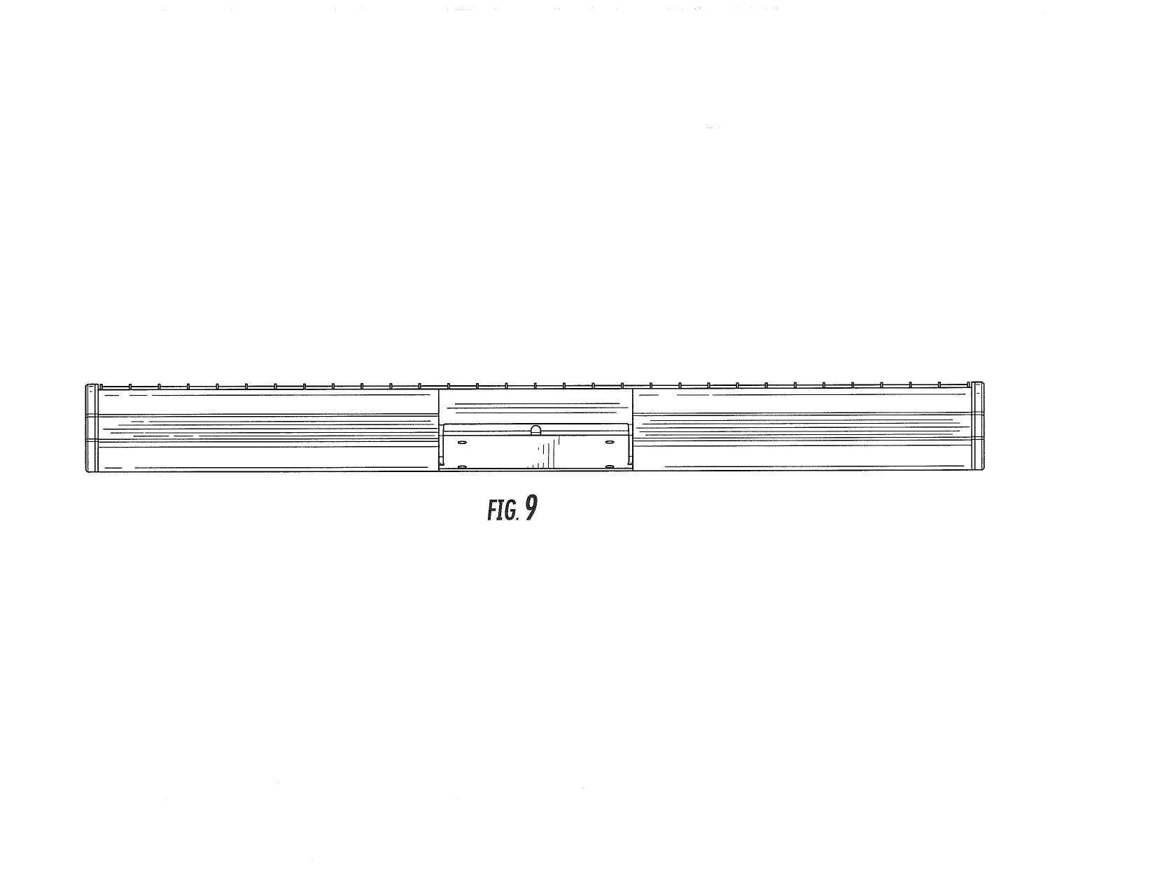

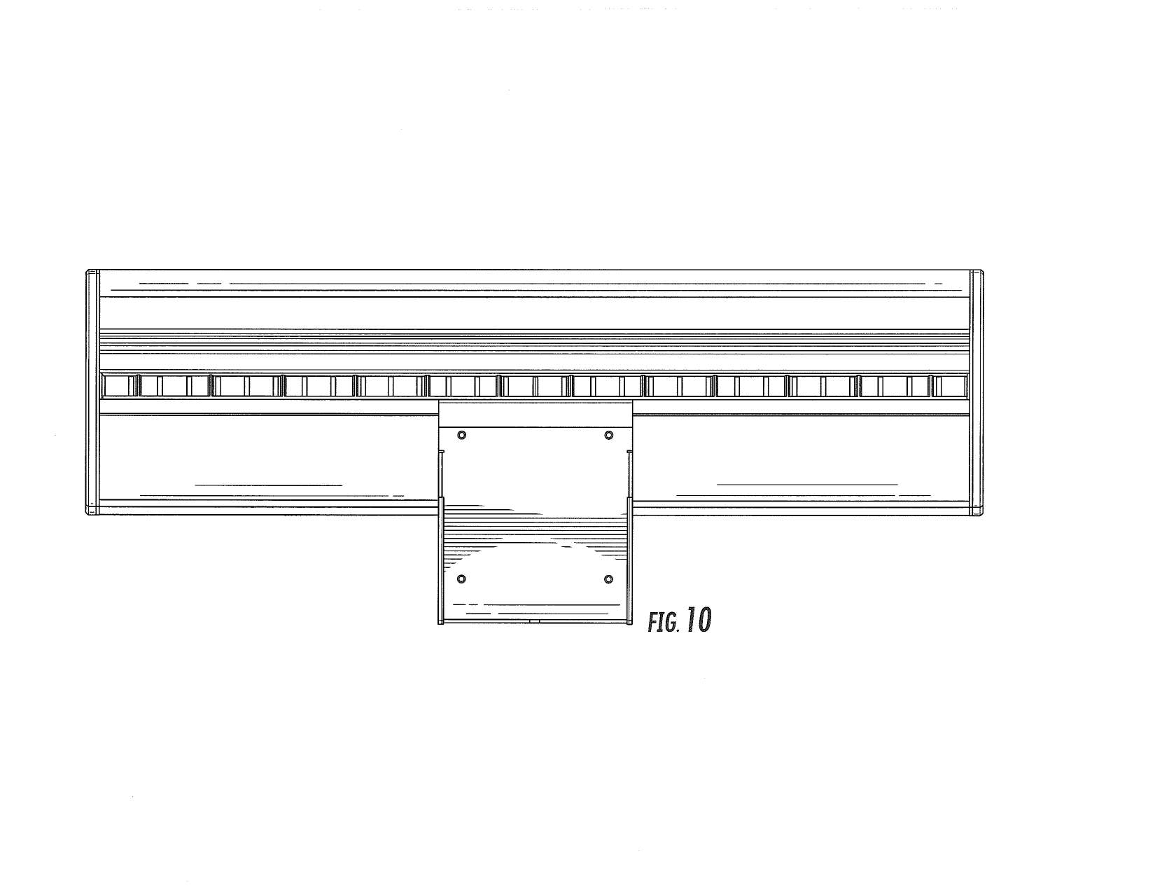

A first exemplary embodiment of a luminaire 10 with a mounting interface 18 is shown in FIGS. 1-3 and 5-10, with an exemplary system 14 for mounting the luminaire 10 being shown in FIG. 4. The features this luminaire 10 and system 14 will be discussed in detail hereinbelow.

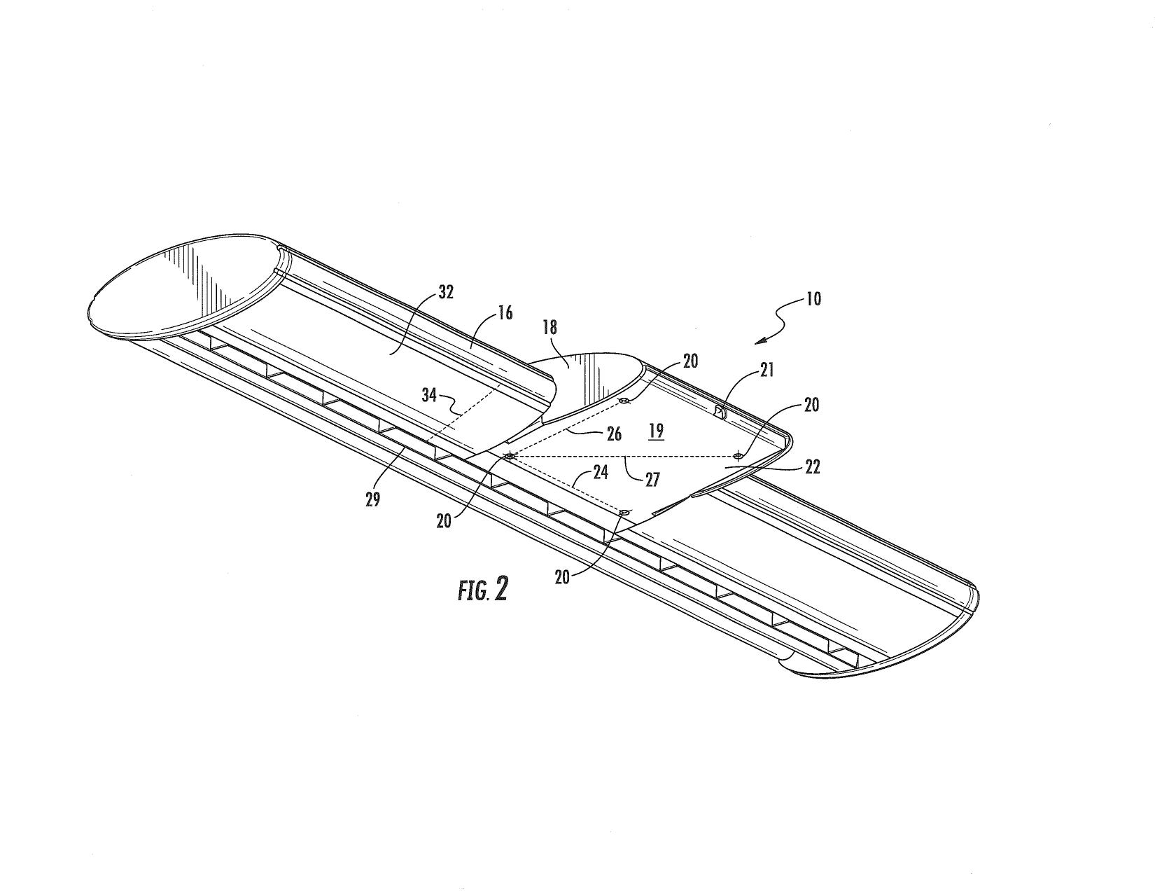

As is best shown in FIGS. 1 and 2, the luminaire 10 includes a luminaire housing 16 and the mounting interface 18. The mounting interface 18 may be removably associated with the luminaire housing 16 (via threaded associations, snap or frictional fitting, etc.), or of integral construction with the luminaire housing 16. The interface 18 may also be retrofittable to an existing luminaire by configuring a relatively inner potion of the interface 18 to mate with an exterior of a known luminaire housing geometry, and providing for any necessary electric connections. The mounting interface 18 includes an interface surface 19 and interface association points or openings 20. There is also an opening 21 included in the body of the interface 18, which allows for access to cords or other electronic components disposed within the interface 18 and the luminaire 10. In the exemplary embodiments shown in the Figures, the interface association points 20 are all threaded openings that may be configured to accept an M4 machine screw fastener. However, male threaded instruments or snap fit extensions may also be used.

As is best shown in FIGS. 2, 8, and 10, the association points 20 (which may be referred to as openings hereinafter) are arranged at the four corners of a substantially square pattern 22. In an “x” or length dimension 24 and the “y” or width dimension 26 of the square pattern 22, the openings 20 are separated by approximately 100 mm. This length is the same for all of the openings 20 separated in these dimensions 24, 26. In the “z” or diagonal dimension 27, the openings 20 are separated by approximately 141 mm (more specifically 141.42 mm). Hereagain, this length is the same for all of the openings 20 separated in this dimension 27. The above discussed dimensions conform to industry standards such as those established by the Video Electronics Standards Association, and allow the luminaire 10 to be associated with the known wide offering of conforming adjustable support apparatus used for positioning VDTs and other workstation resources relative to office workstations and the occupants thereof.

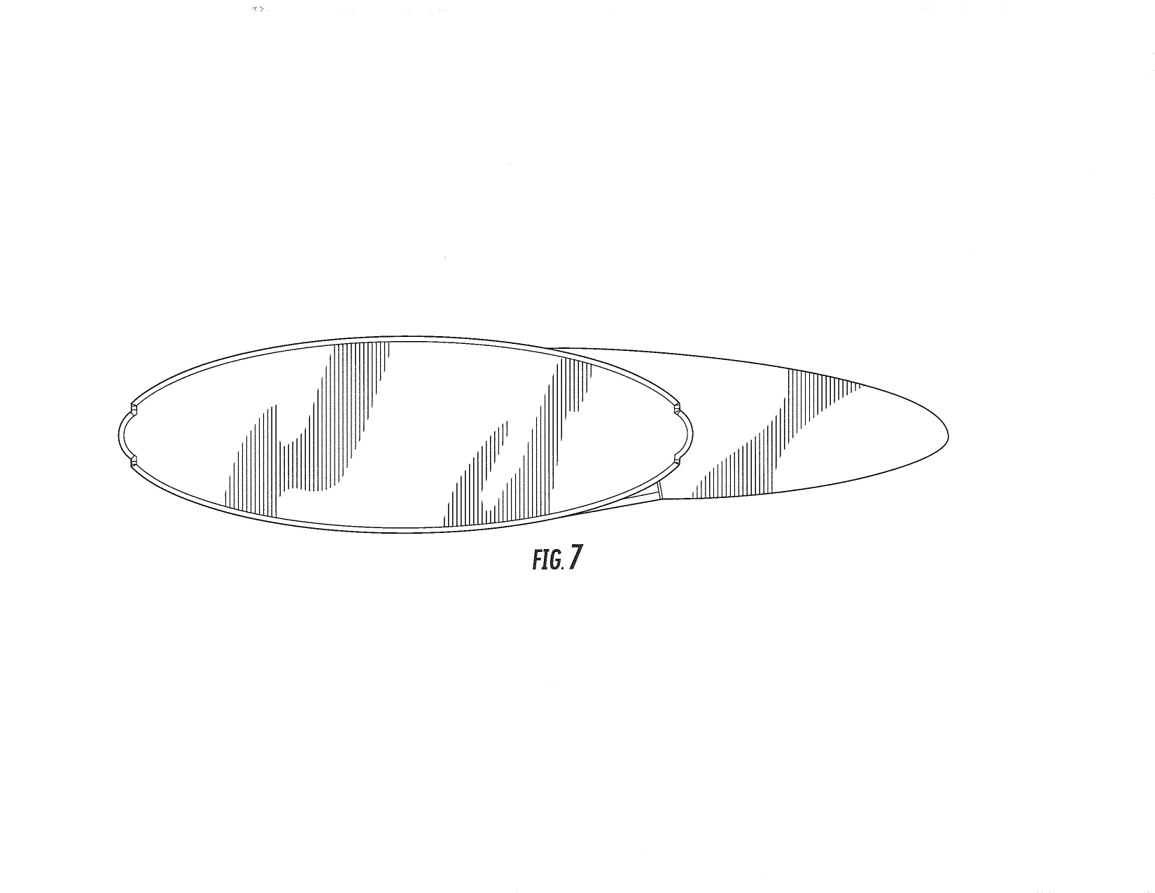

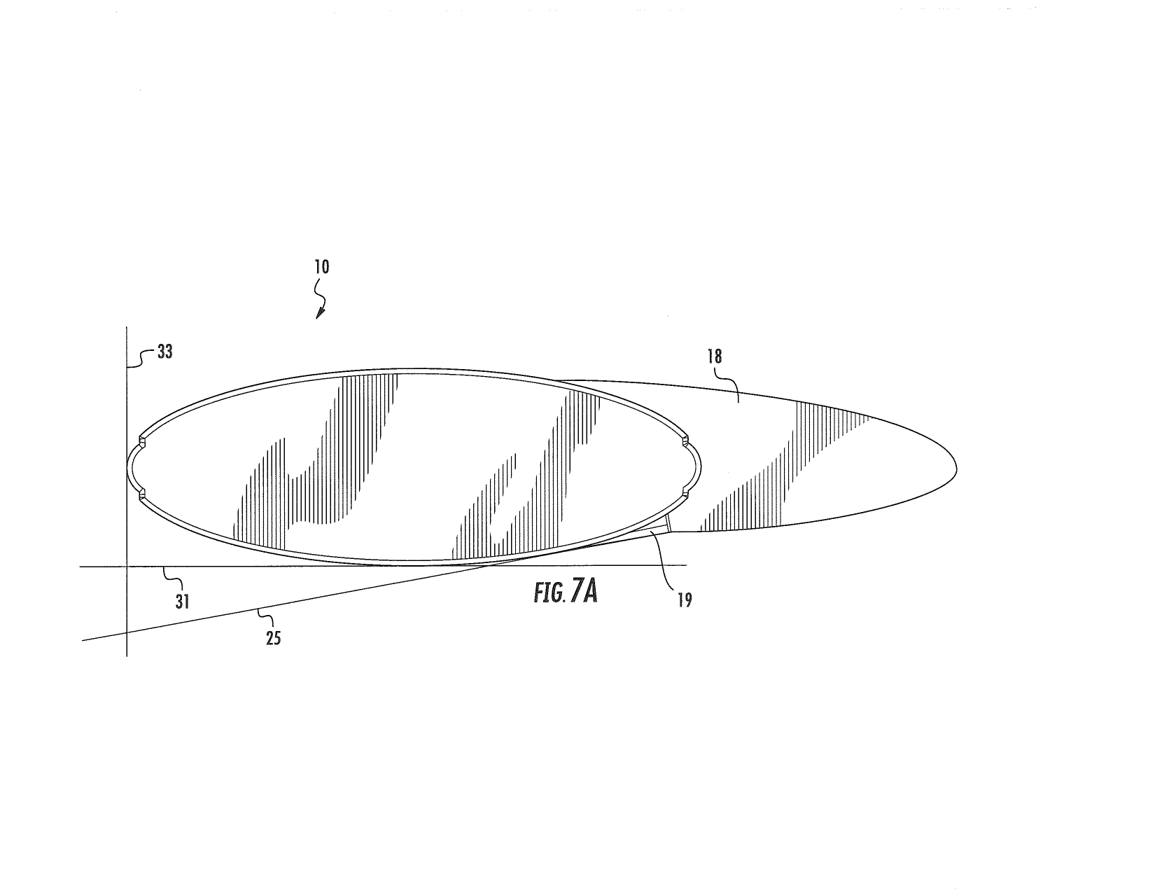

Notably, and as shown in the exemplary embodiments depicted throughout the Figures, the mounting interface 18 and surface 19 thereof extend from the luminaire such that interface surface 19 at least partially overlaps with the housing 16 of the luminaire 10 in a non-vertical plane relative to the luminaire 10. The interface surface 19 is shown to be angled slightly above horizontal in plane 25 of Figures, This is best shown in FIG. 7a, which also includes horizontal plane 31 and vertical plane 33 of the luminaire 10, and shows plane 25 relative thereto. Of course, any horizontal orientation of the interface surface 19 (e.g. directly in plane 31) or substantially horizontal orientation is also contemplated.

As shown in FIG. 2, the portion of the interface surface 19 that overlaps with the luminaire housing includes two of the association openings 20. This extension of the interface surface 19 out from the housing 16 of the luminaire 10 is important for various reasons, particularly when the luminaire contemplated is a task ambient luminaire (with both an uplight aperture 28 and downlight aperture 29), as is the case in the exemplary embodiments shown throughout the Figures.

Indeed, the task ambient luminaires that are most commonly used in office workstation environments typically include a non-aperture top surface 30 and non-aperture bottom surface 32 that are less than approximately 141 mm (141.42 mm), and more particularly less 100 mm or 75 mm, in a width dimension 34 thereof. As such, successful association of the interface surface 19 with the luminaire 10 would be unexpected by one of ordinary skill in the art, since the industry standard distance between the openings 20 is greater (100 mm) than the width 34 of surfaces 30 and 32 available for mounting the interface surface 19. As shown the Figures, surfaces disposed at other portions of the luminaire 10, such as a relative back surface, also include width dimensions that are insufficient for accommodating the interface surface 19 and openings 20 disposed thereon.

This issue was successfully addressed in a manner that would avoid blocking or partially blocking the uplight or downlight apertures 28, 29 via extension of the interface surface 19 from the housing of the luminaire 16. Furthermore, disposal of the interface surface 19 in a non-vertical plane relative to the luminaire 10 advantageously achieves a low profile by preventing extension of the mounting interface 18 from exceeding the overall height of the luminaire 10. By avoiding extension of the interface 18 above and/or below the height of the luminaire 10, interference with light emanating from the luminaire apertures 28, 29 is again prevented. Of course, this is just one manner of overcoming the issues pertaining to non-aperture surface availability, as, for example, positioning the surface 19 in any plane relative to the luminaire 10 and extending the surface 19 entirely away from the housing 16 (without any overlap) to a distance that would not interfere with light emanating from the luminaire apertures 28, 29 via an intermediate, associating structure may also address this issue, and is contemplated herein.

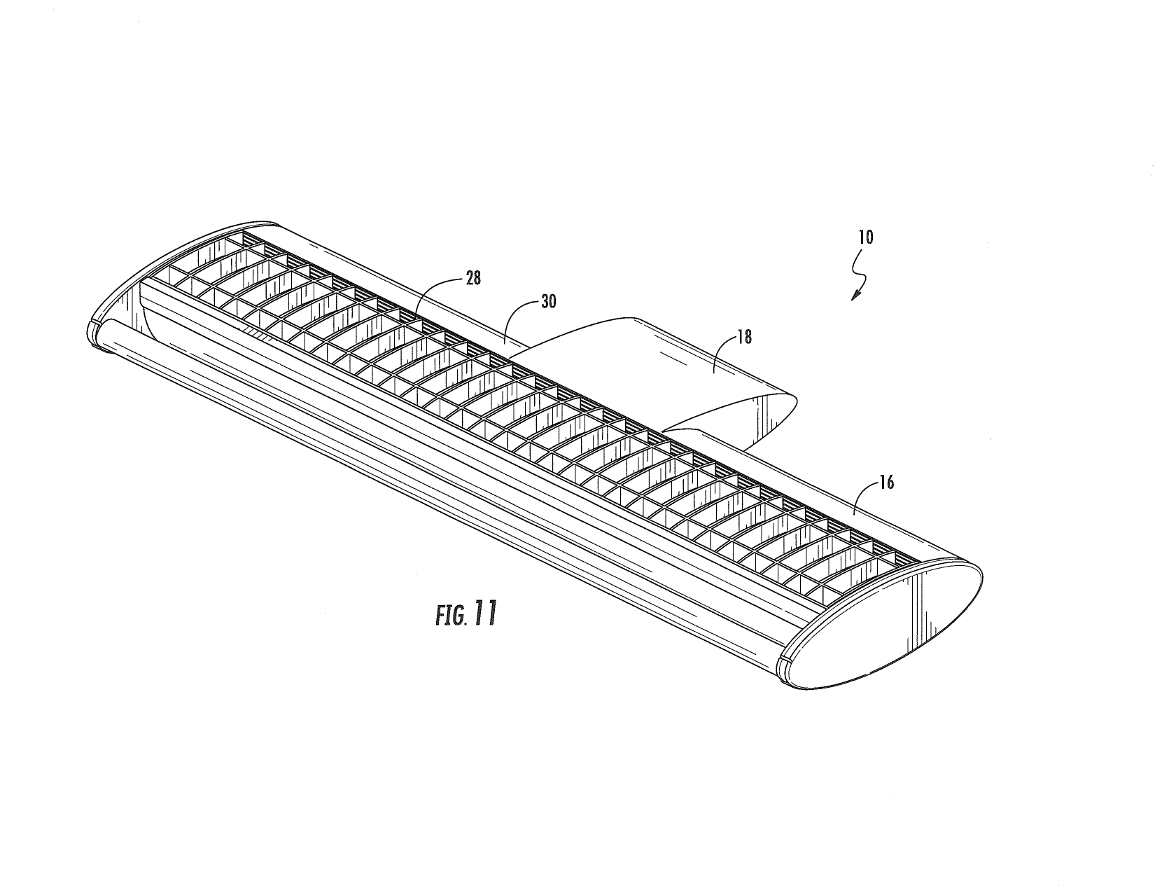

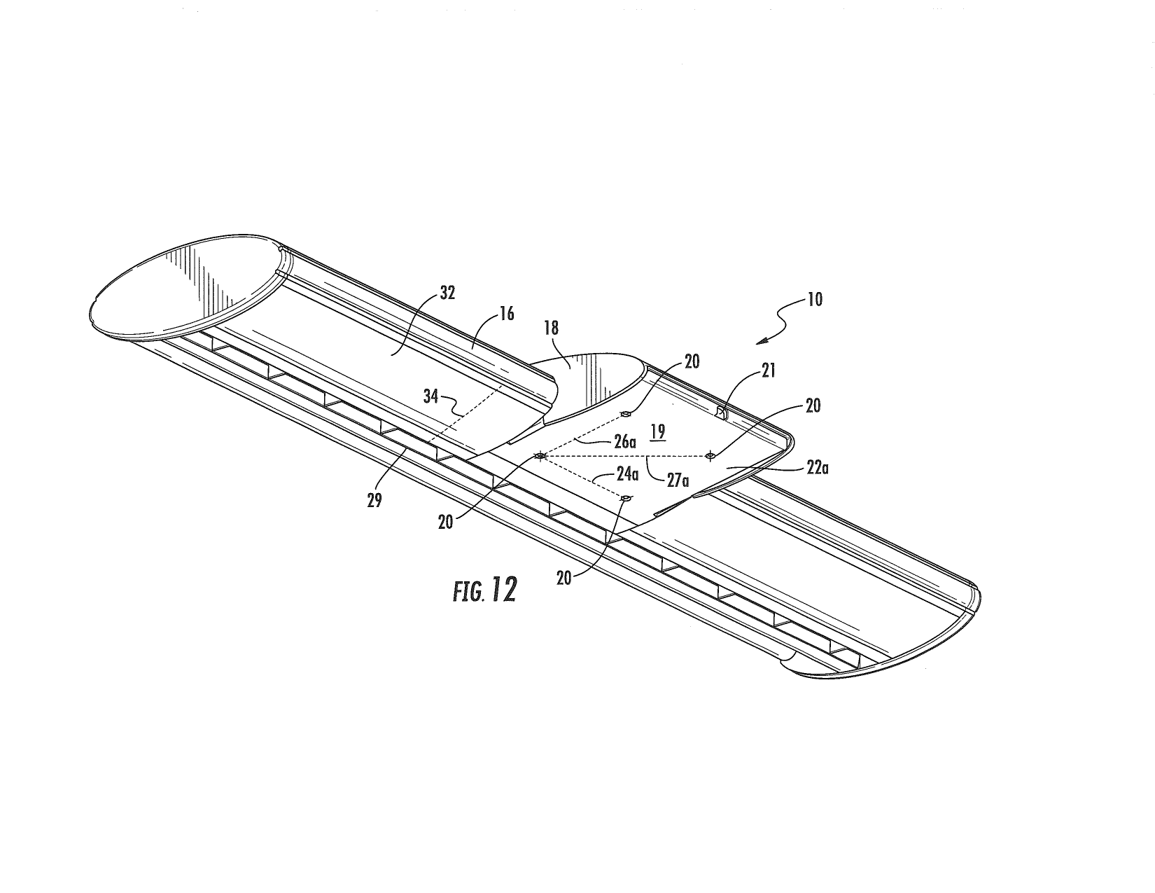

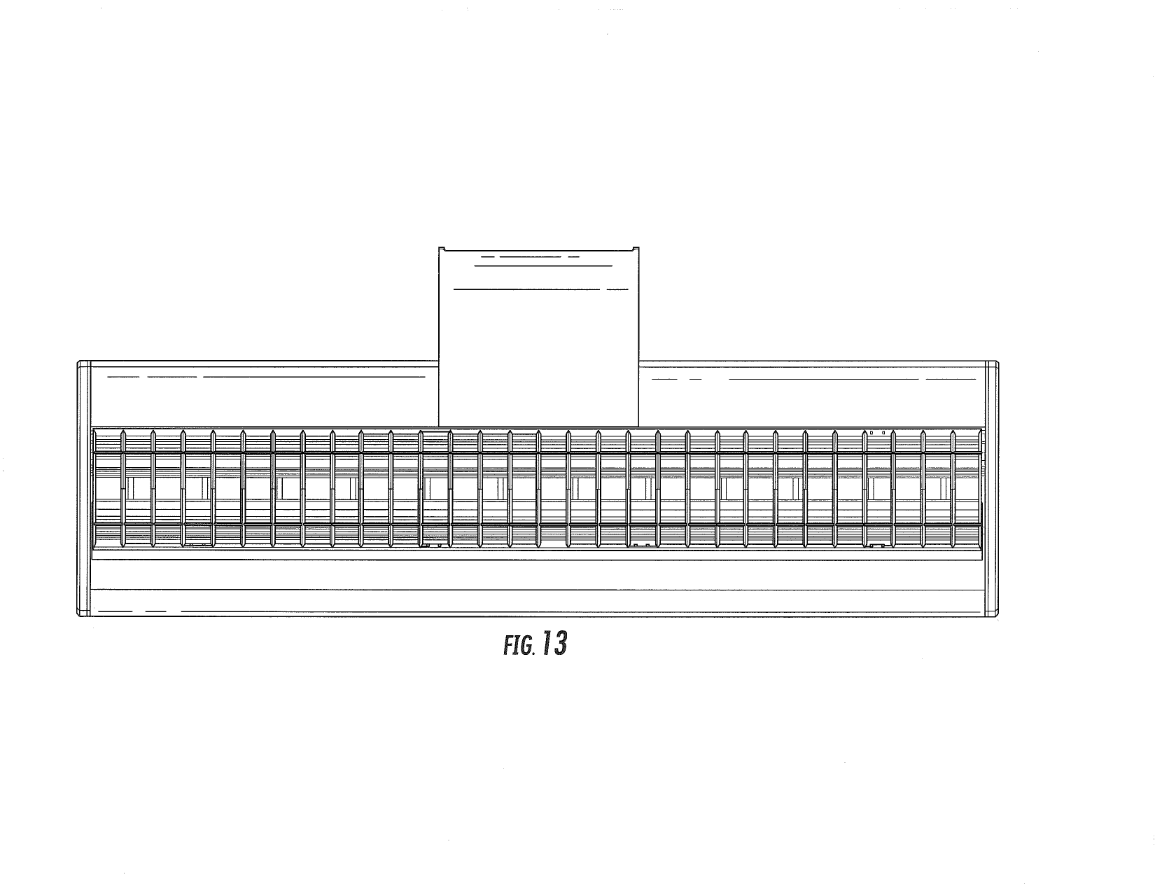

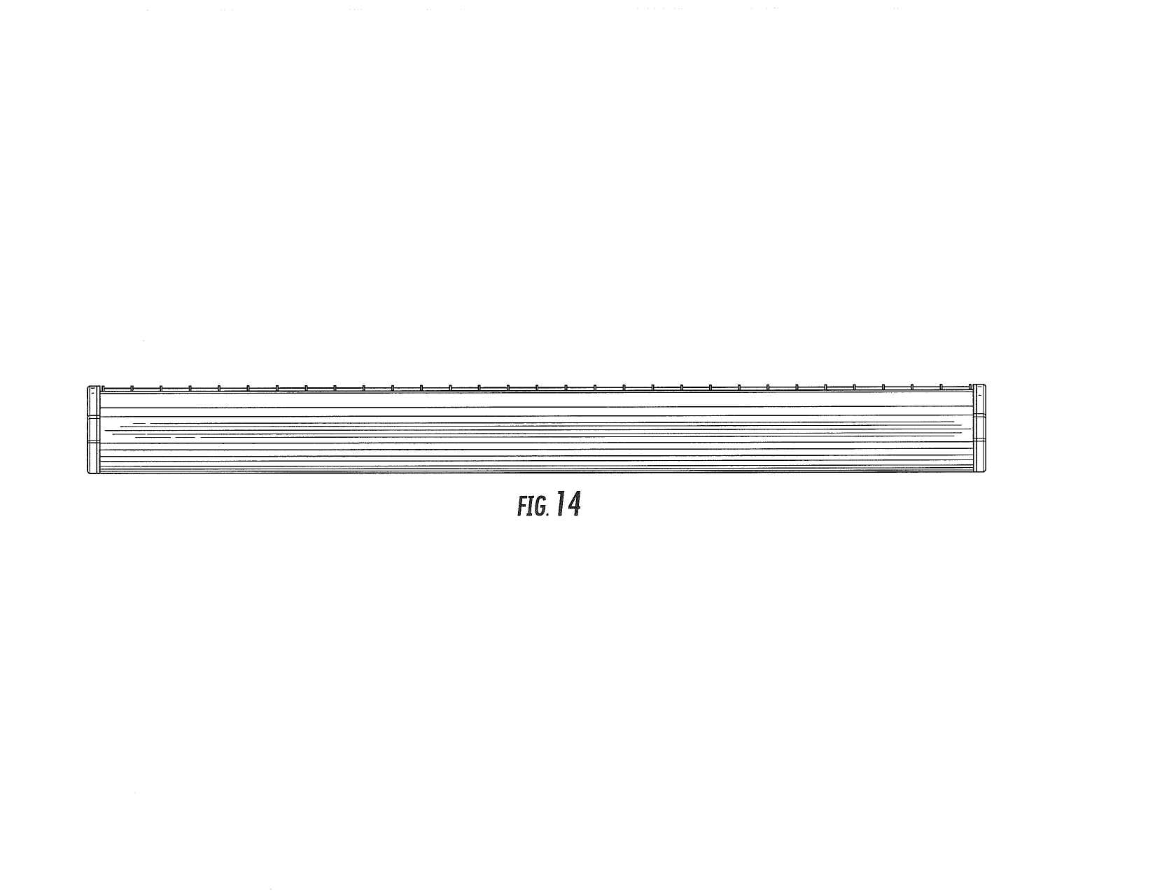

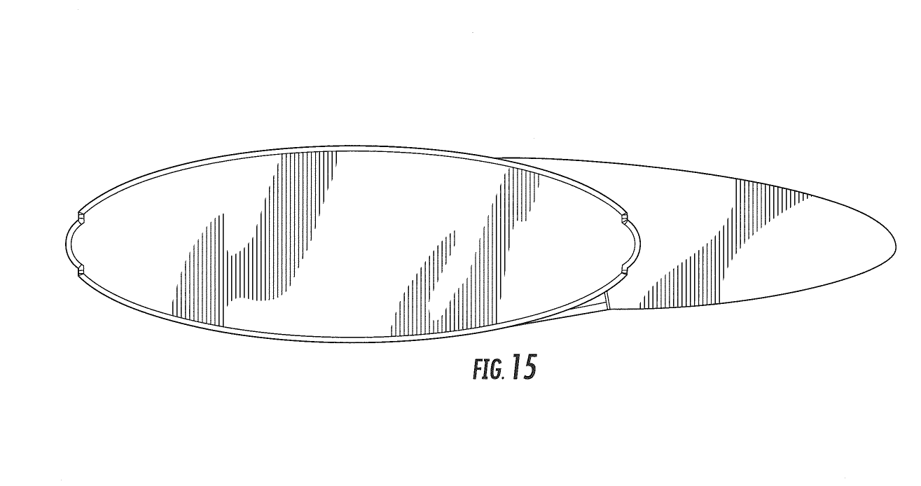

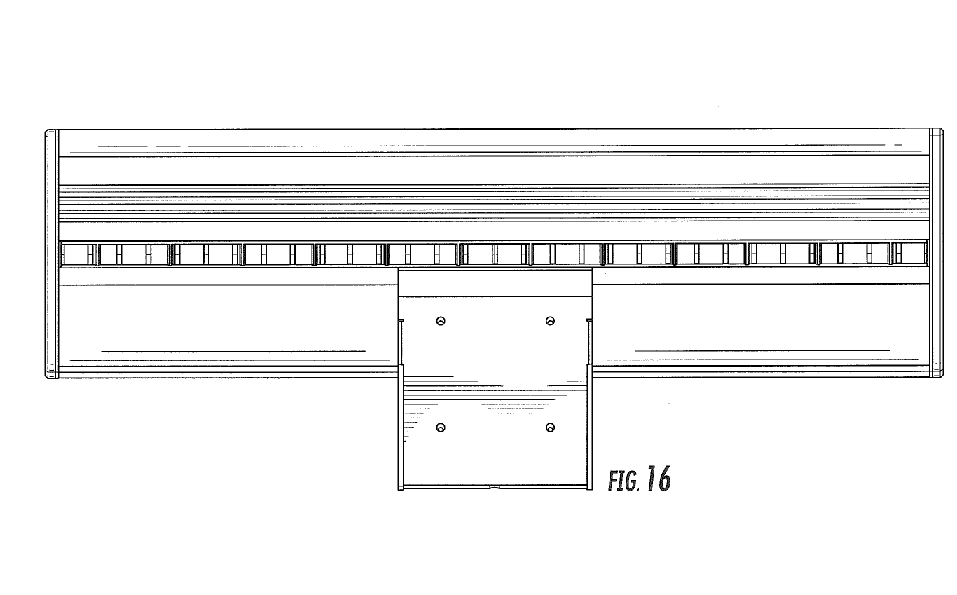

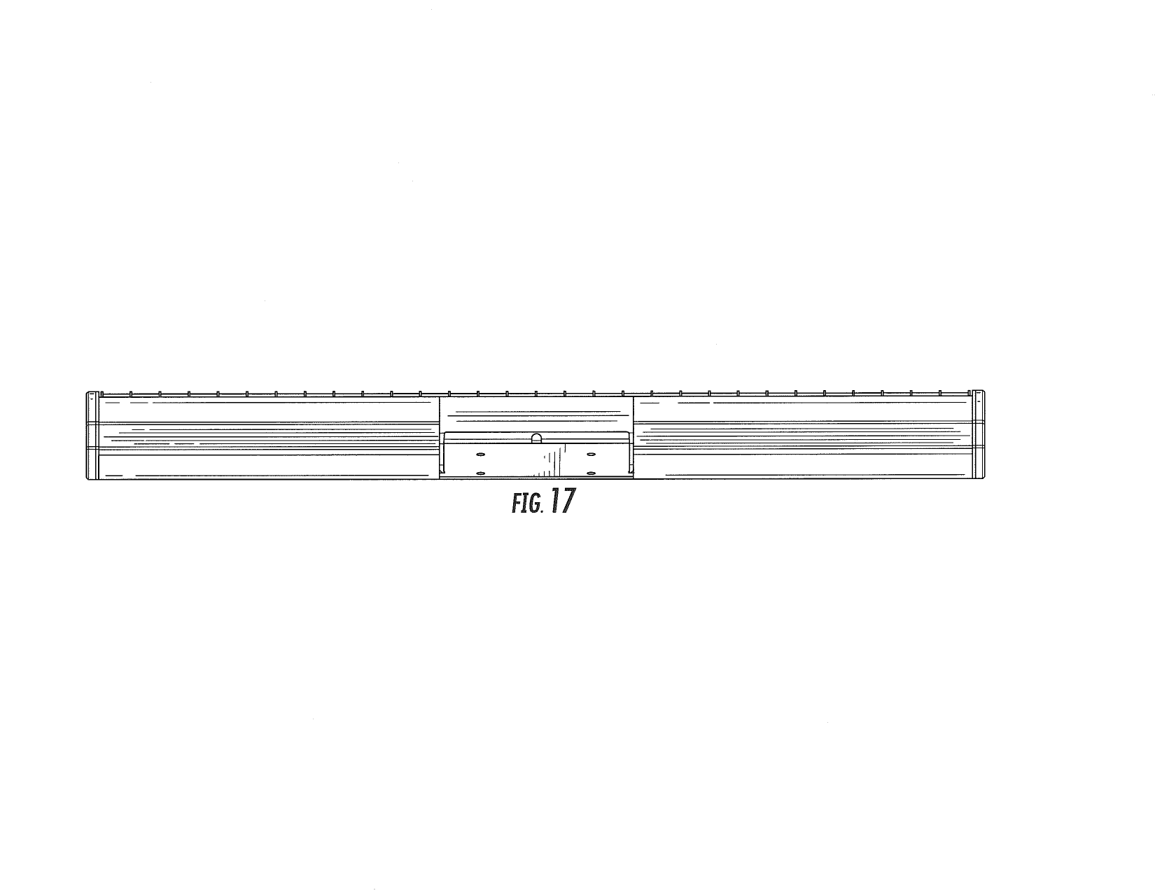

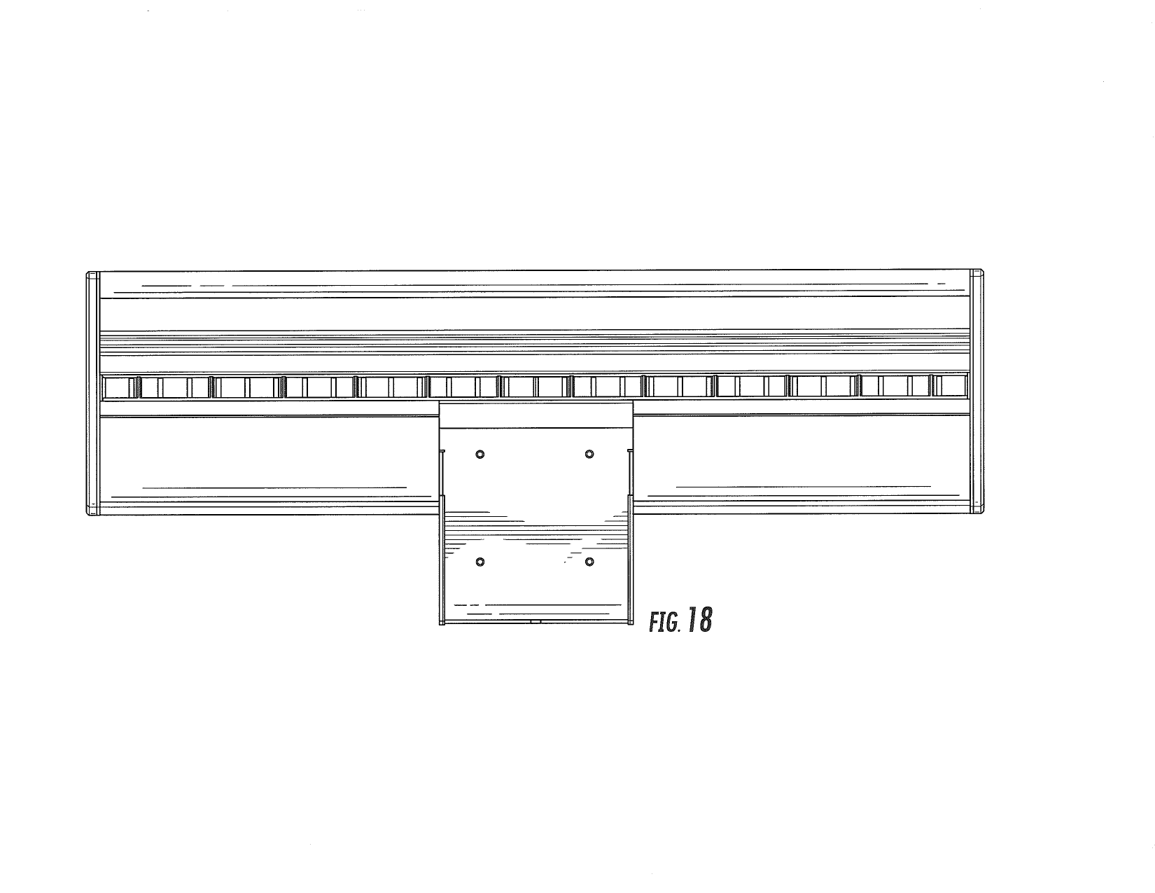

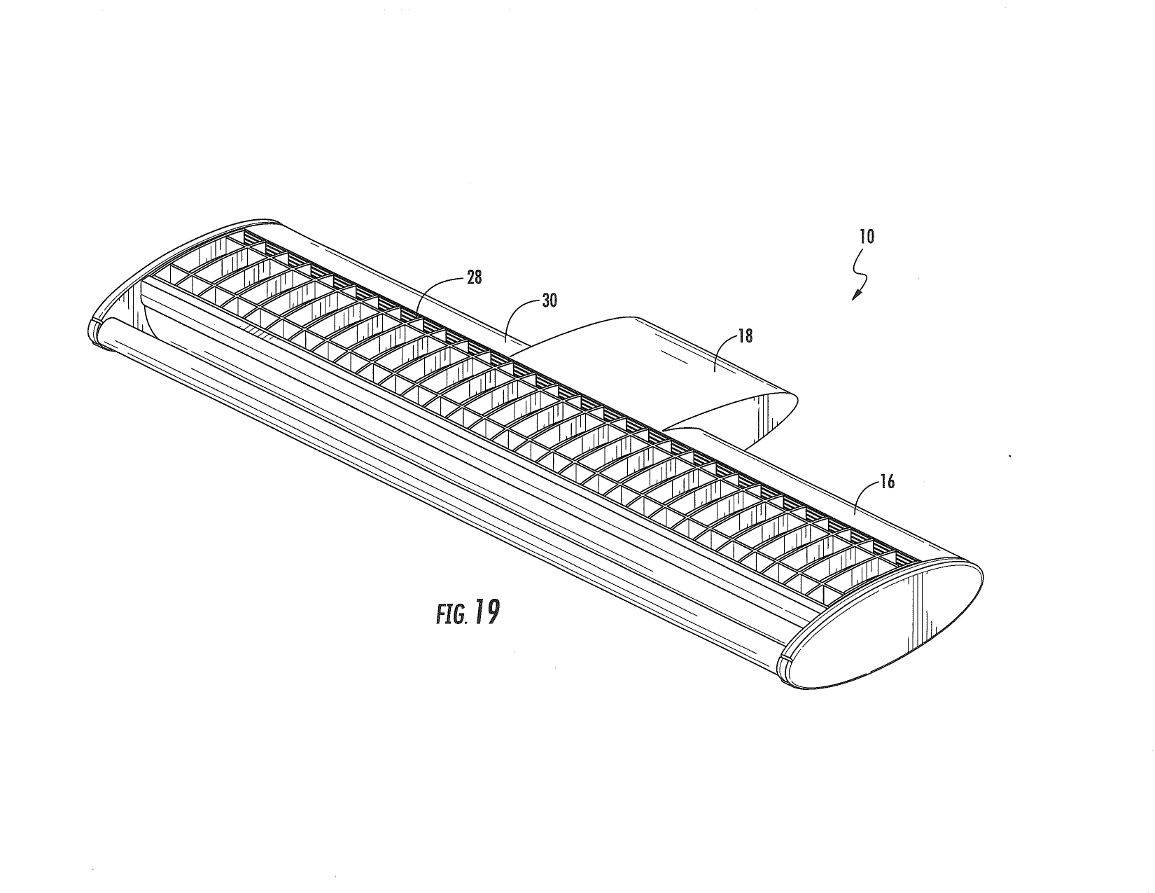

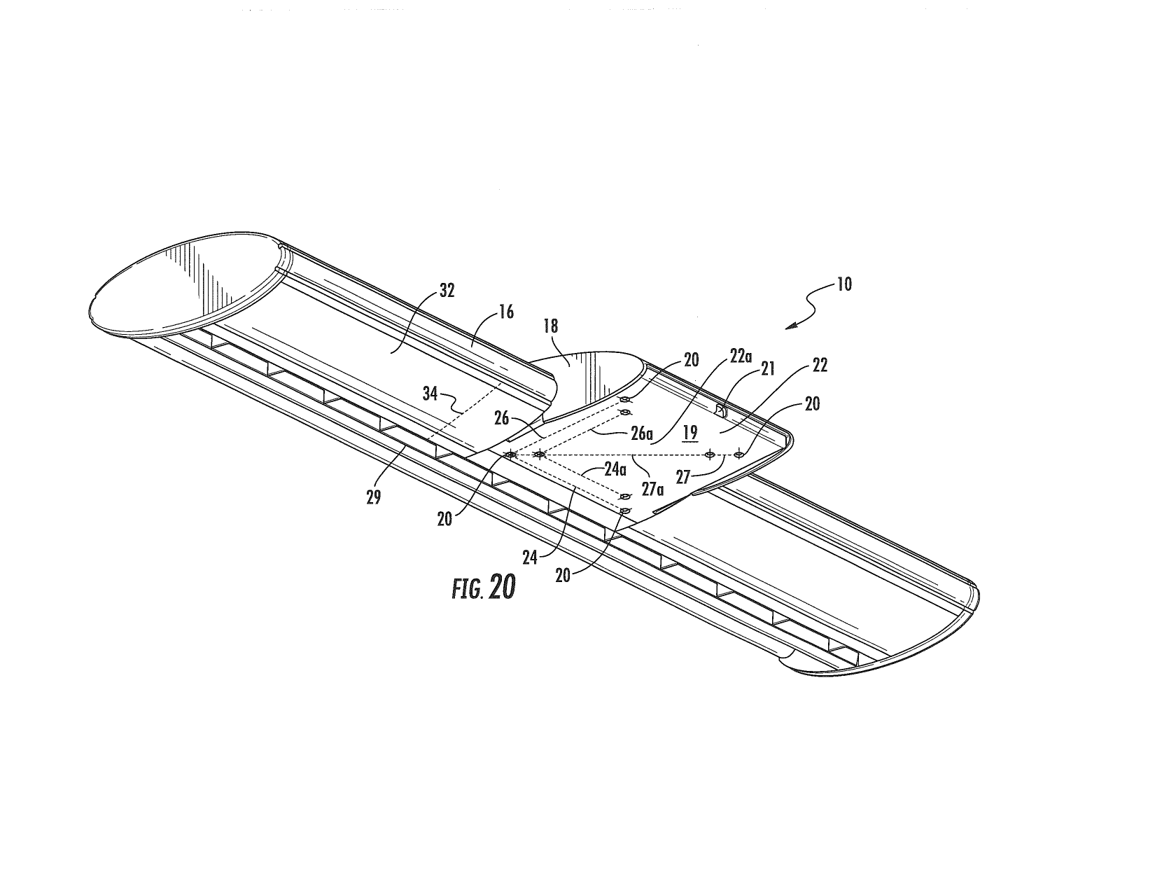

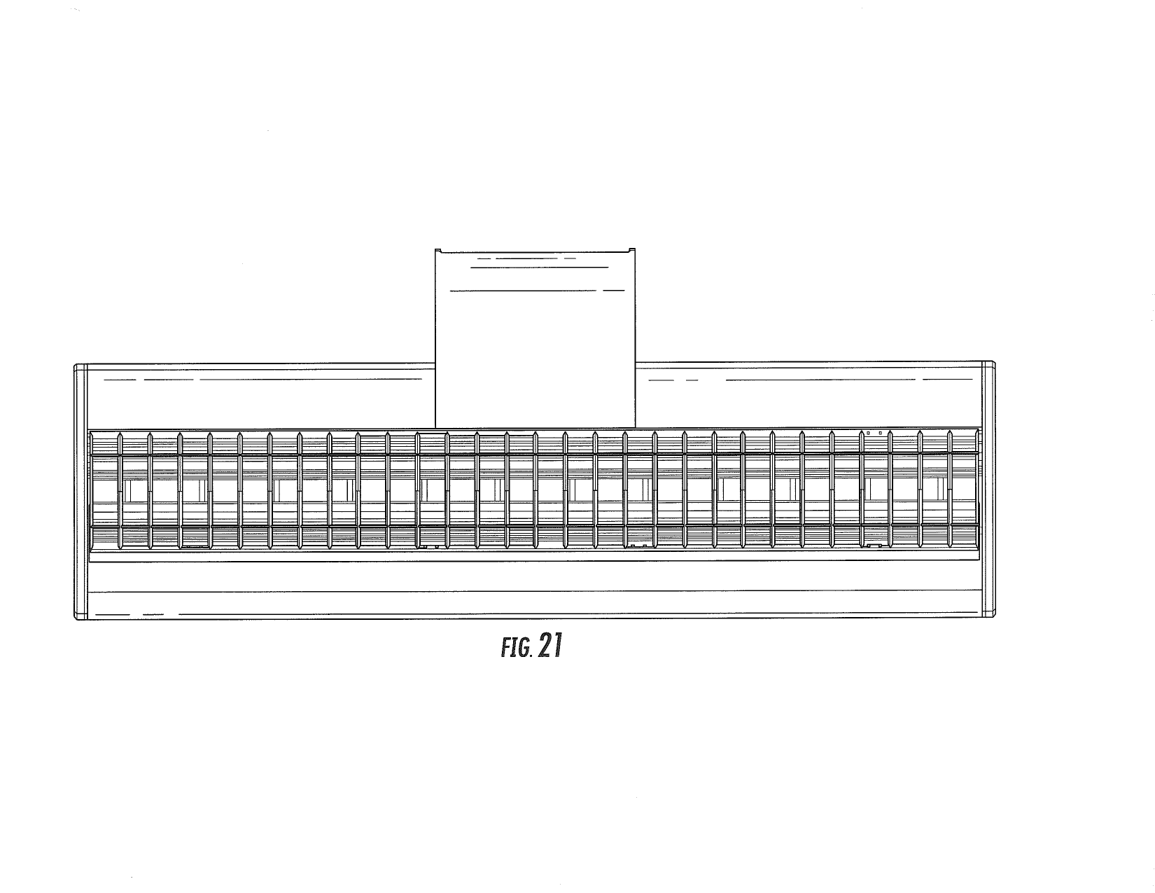

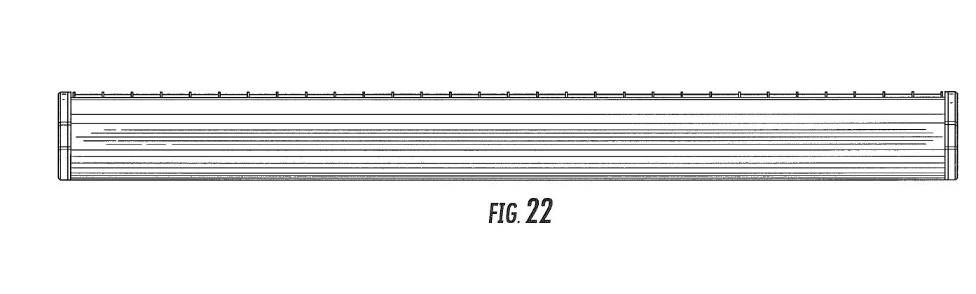

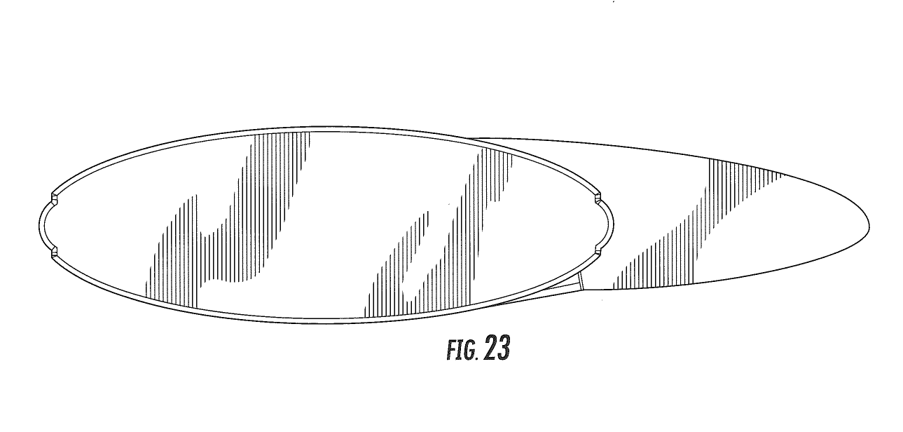

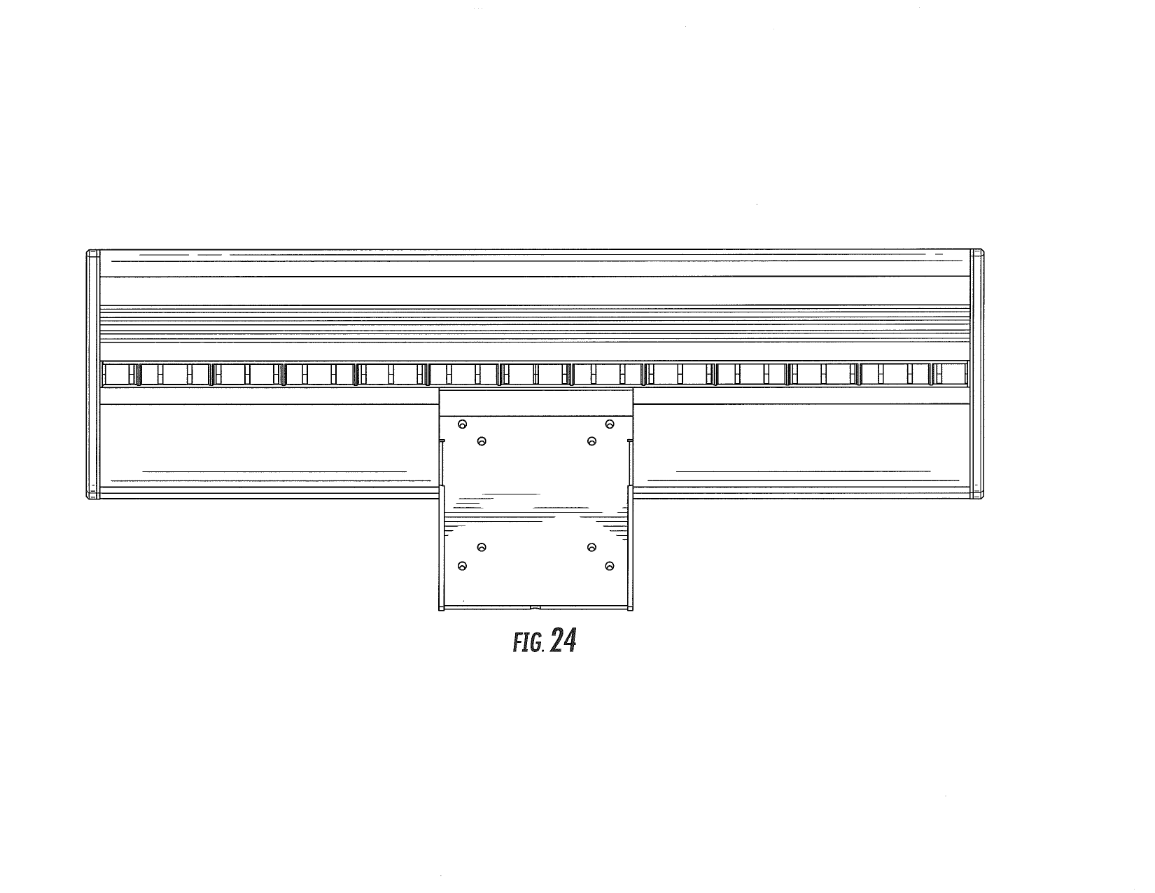

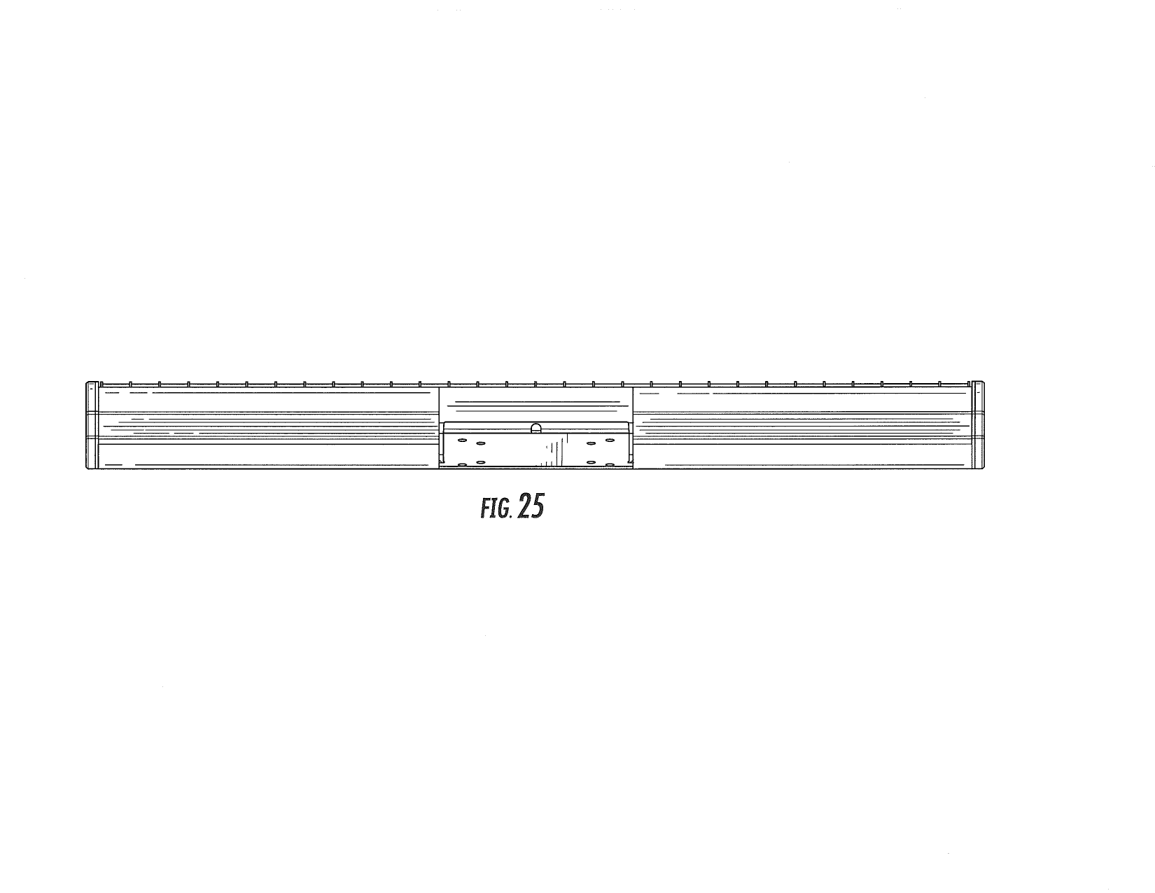

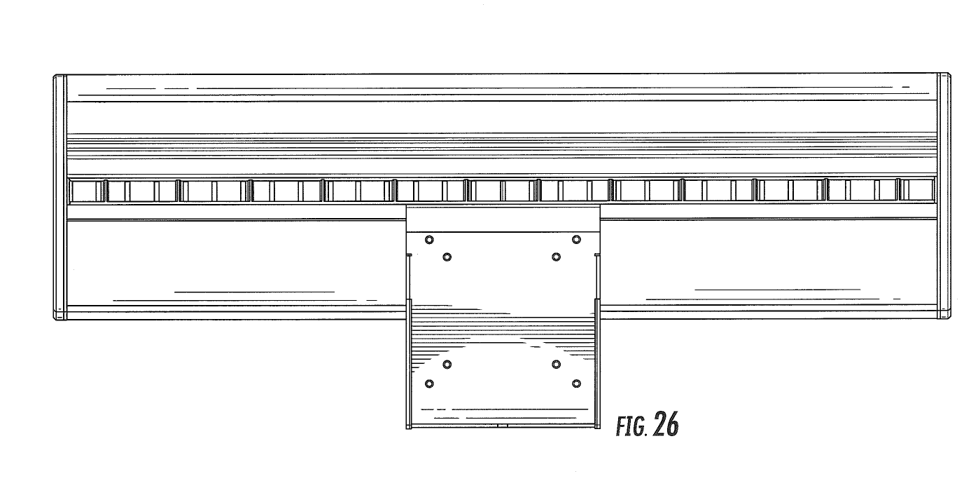

Turning now to FIGS. 11-18 and FIGS. 19-26 respectively, exemplary embodiments are shown that differ from the embodiment of FIGS. 1-10 via the association points/openings 20 only. That is, in the embodiment of FIGS. 11-18 the “x” or length dimension 24a and the “y” or width dimension 26a of second square pattern 22a include a separation between the openings 20 of approximately 75 mm, while the “z” or diagonal dimension 27a includes a separation between the openings of approximately 106 mm (more particularly 106.07 mm). The embodiment of FIGS. 19-26 includes first and second square patterns 22 and 22a with openings 20 separated by distances as shown in both the embodiment of FIGS. 1-10 and FIGS. 11-18.

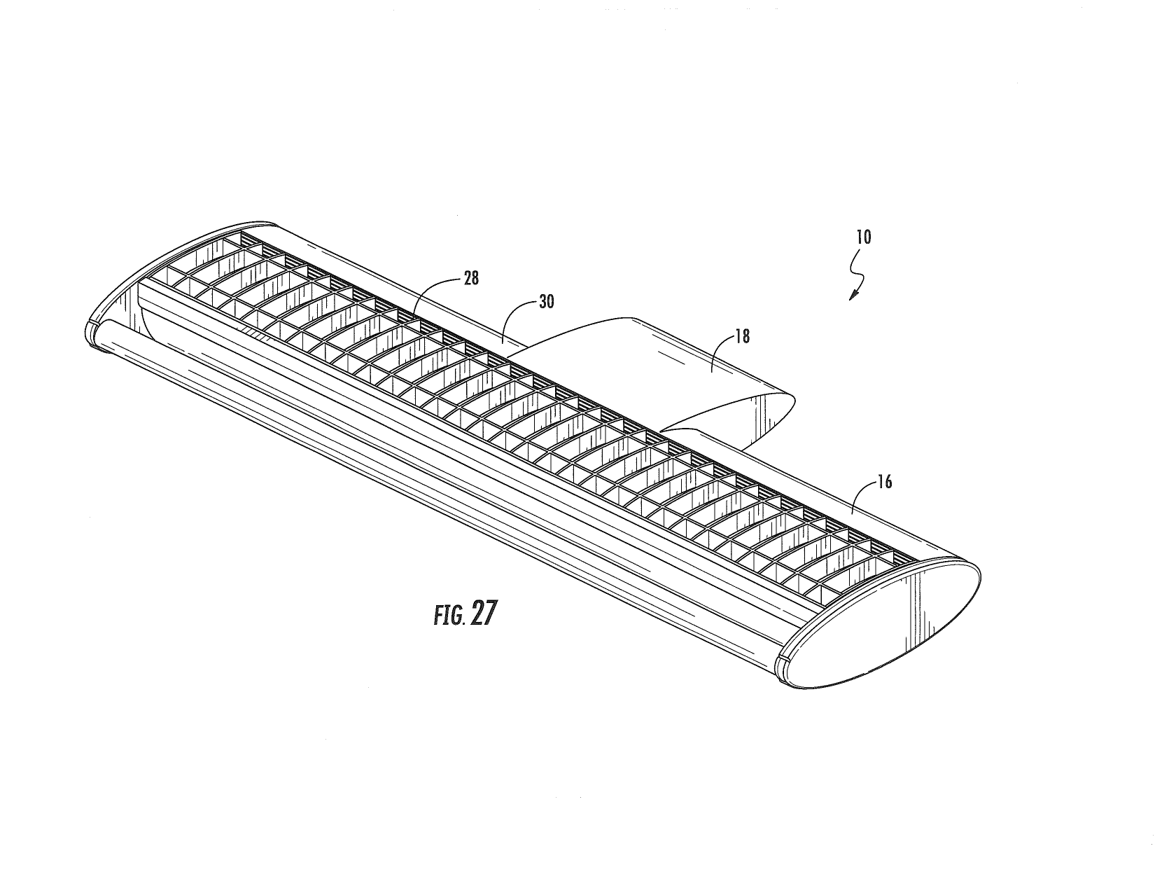

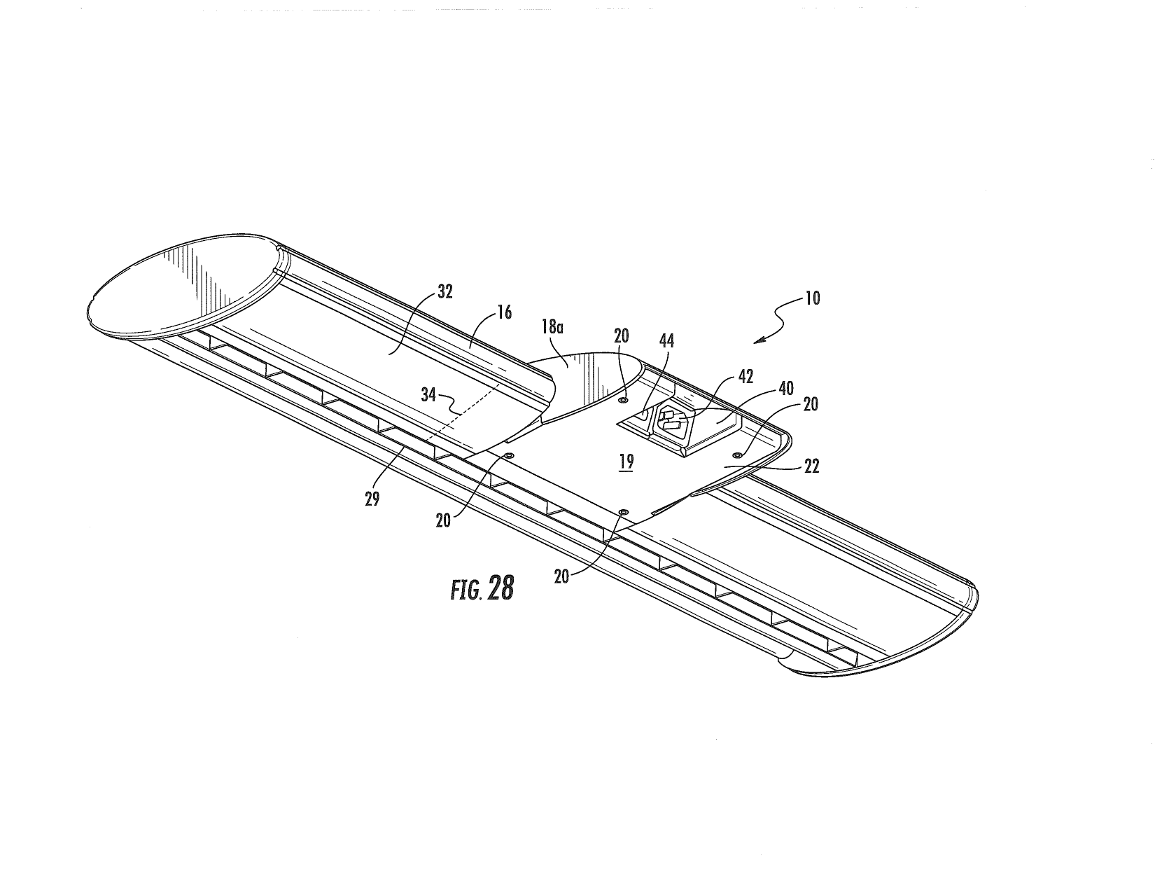

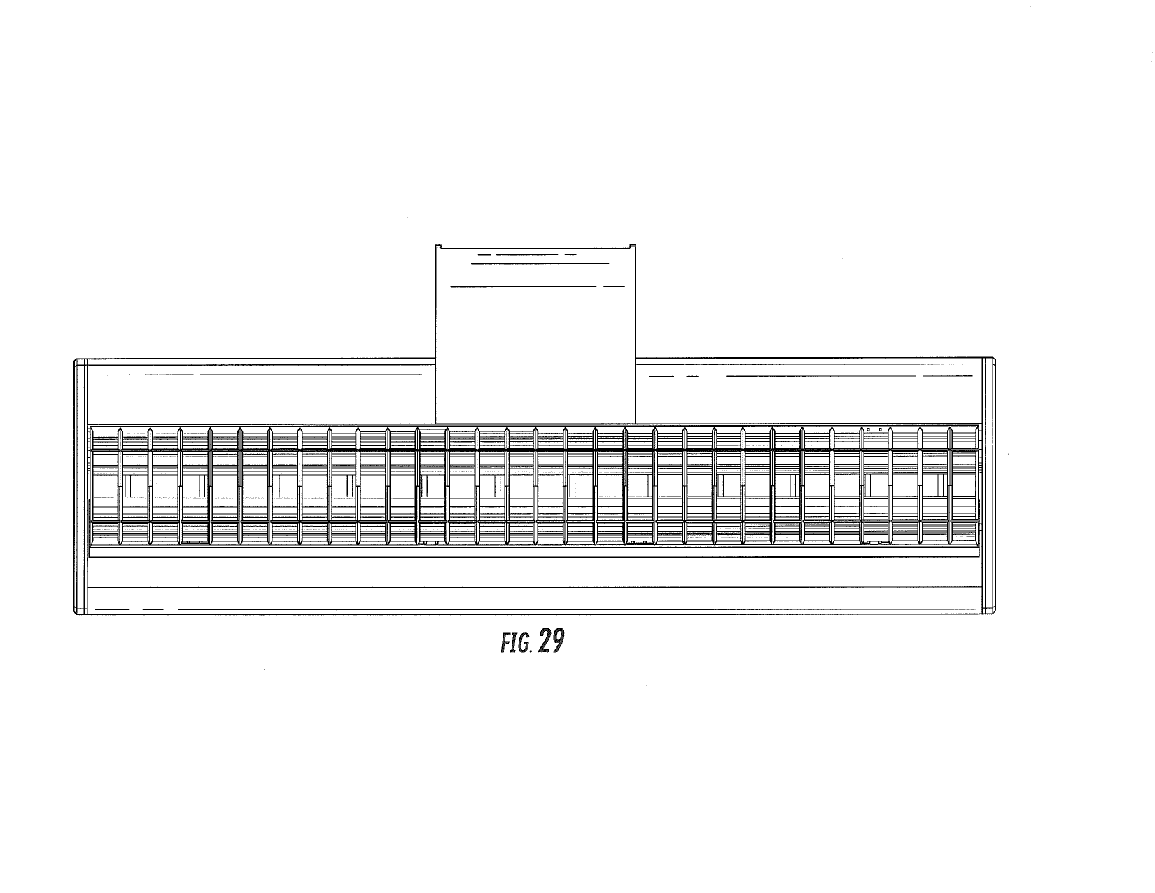

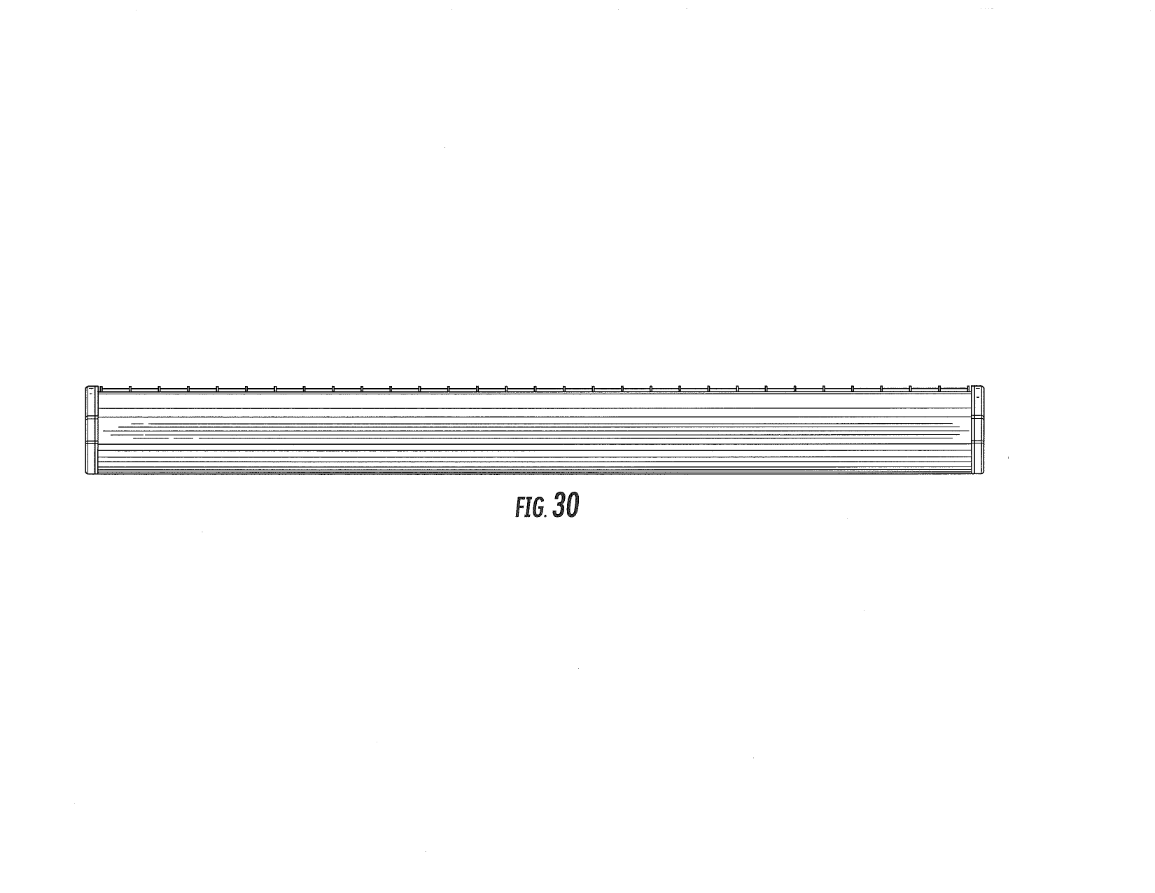

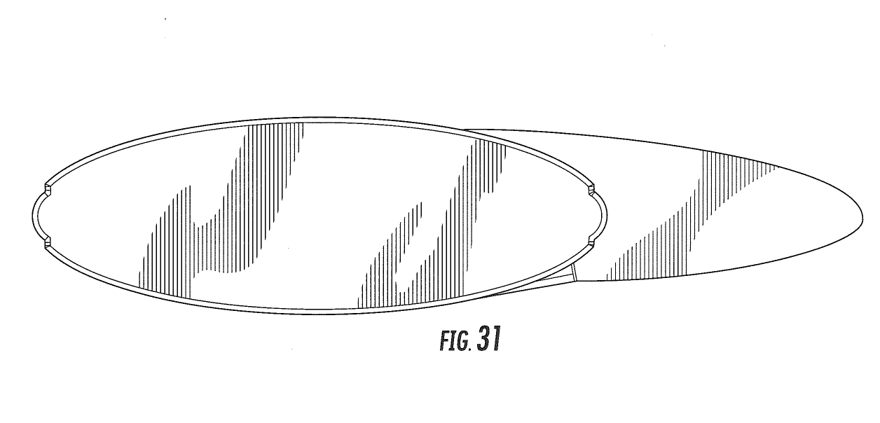

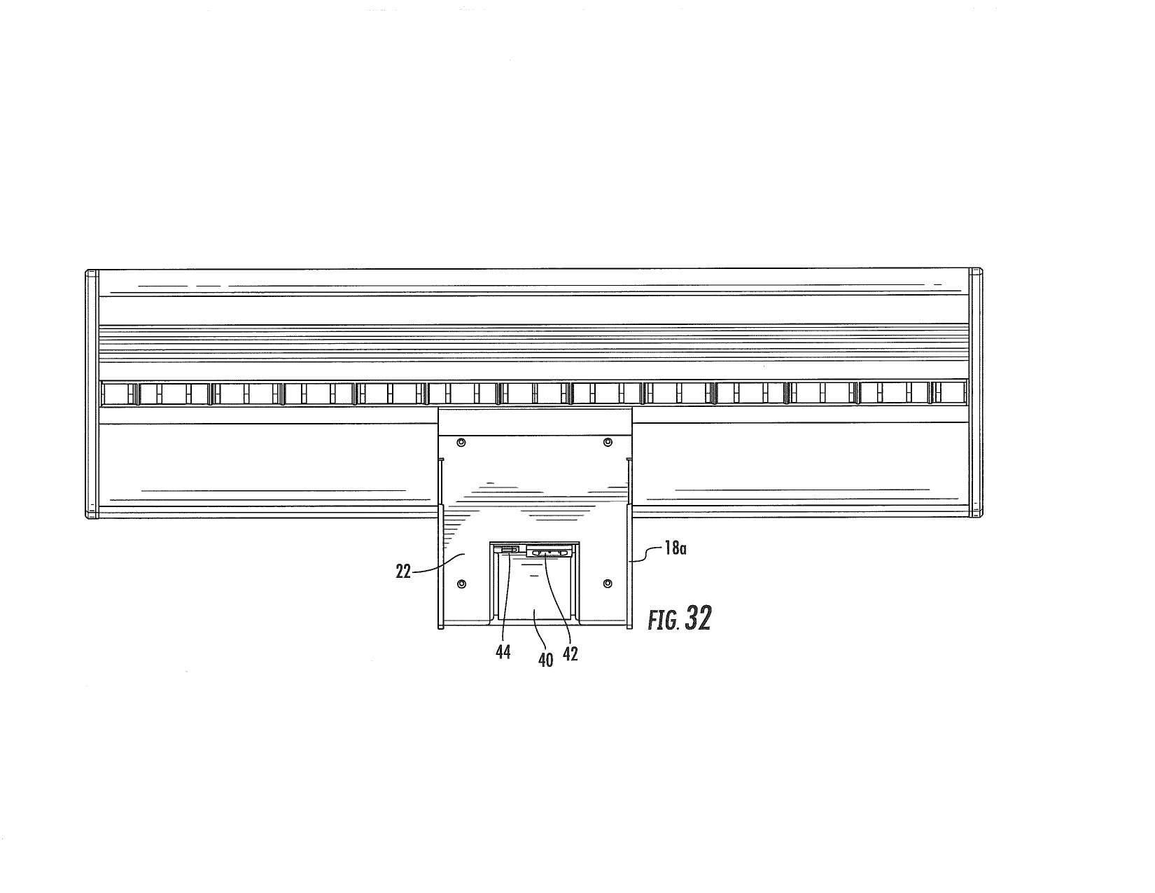

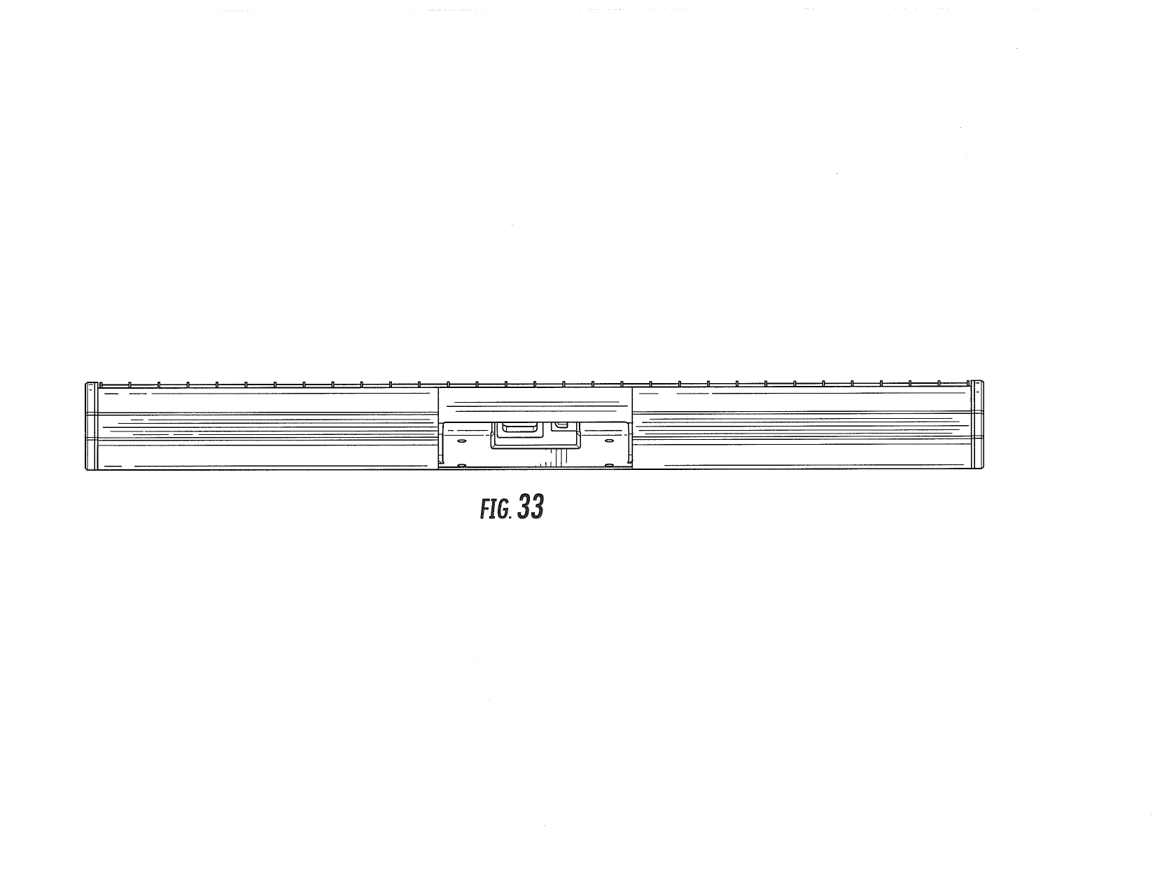

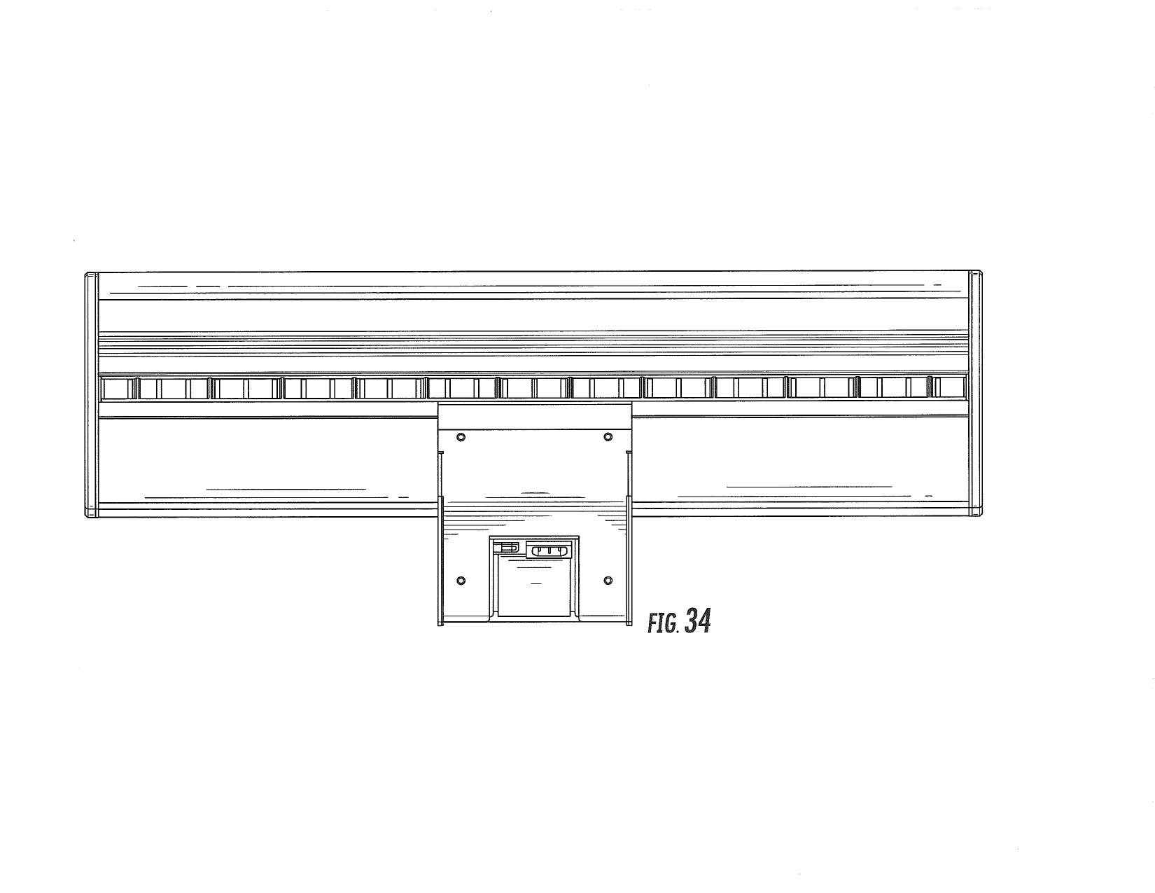

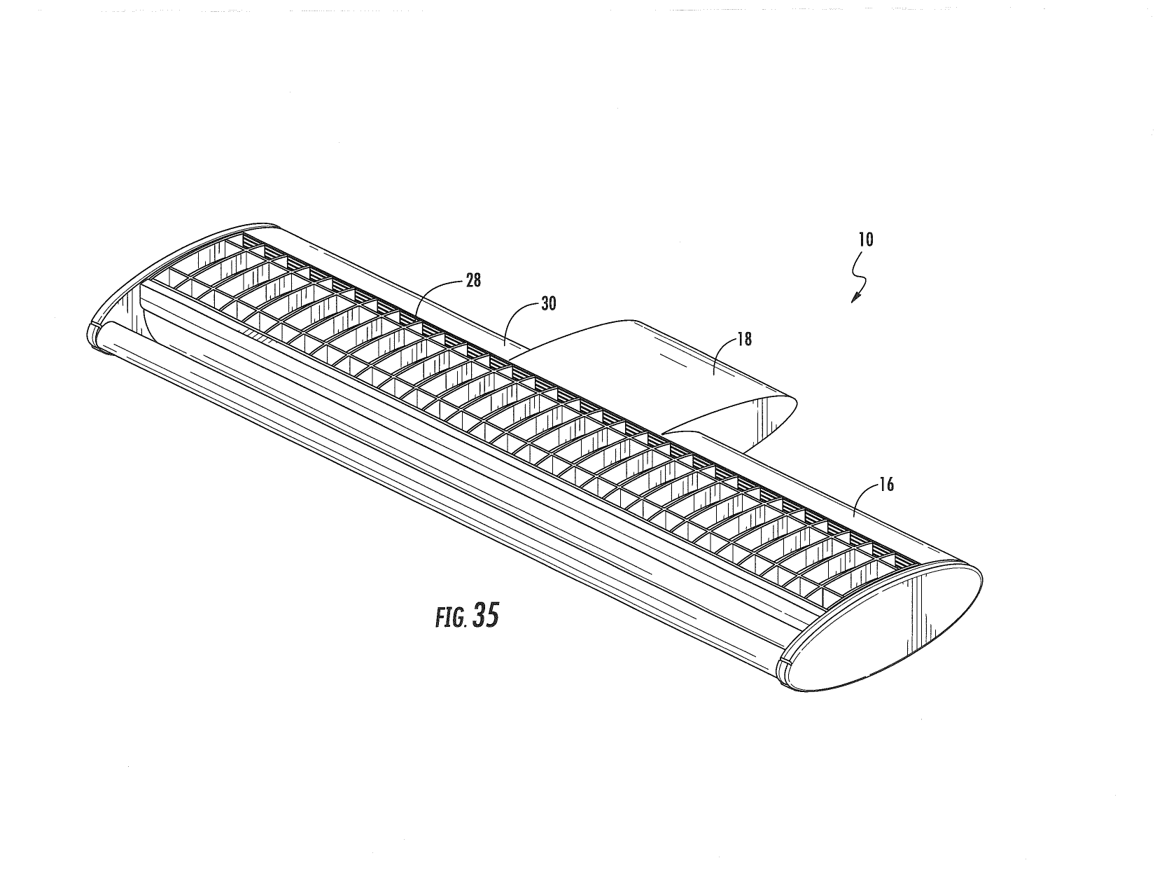

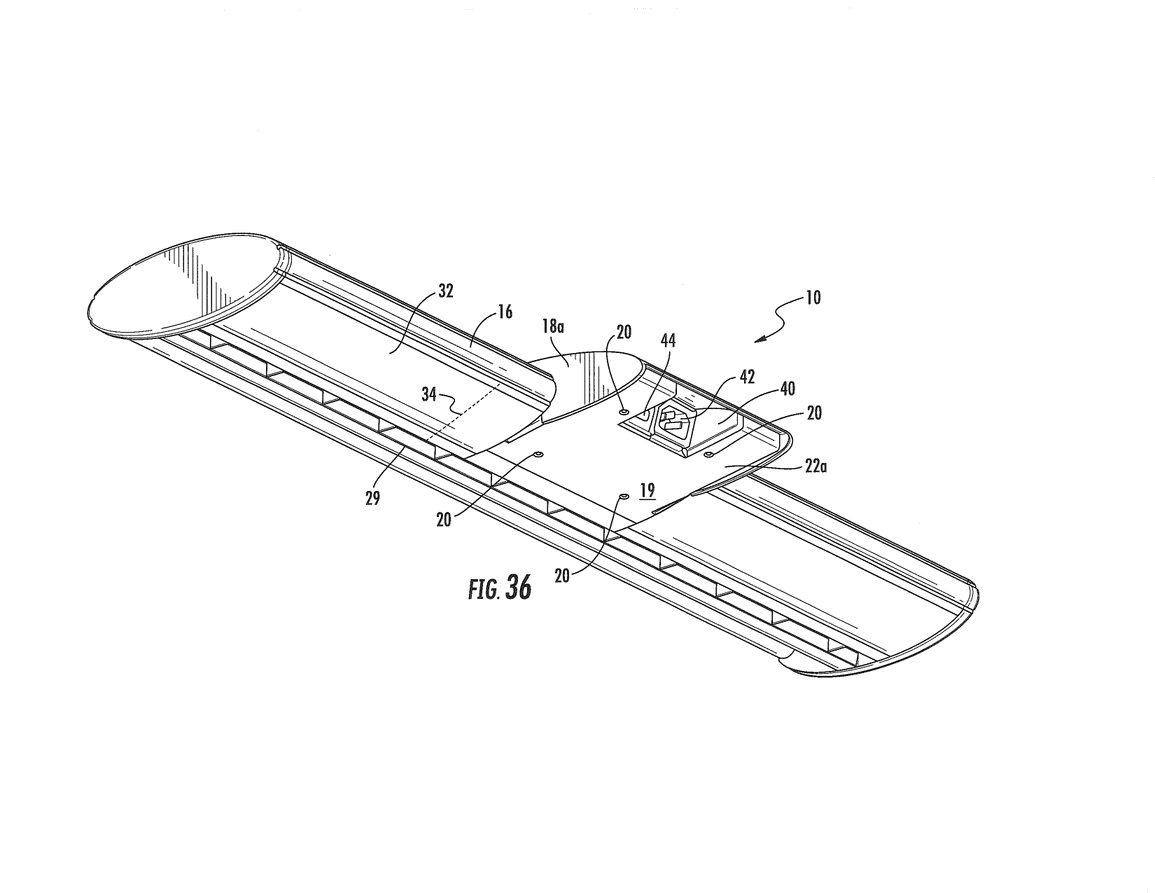

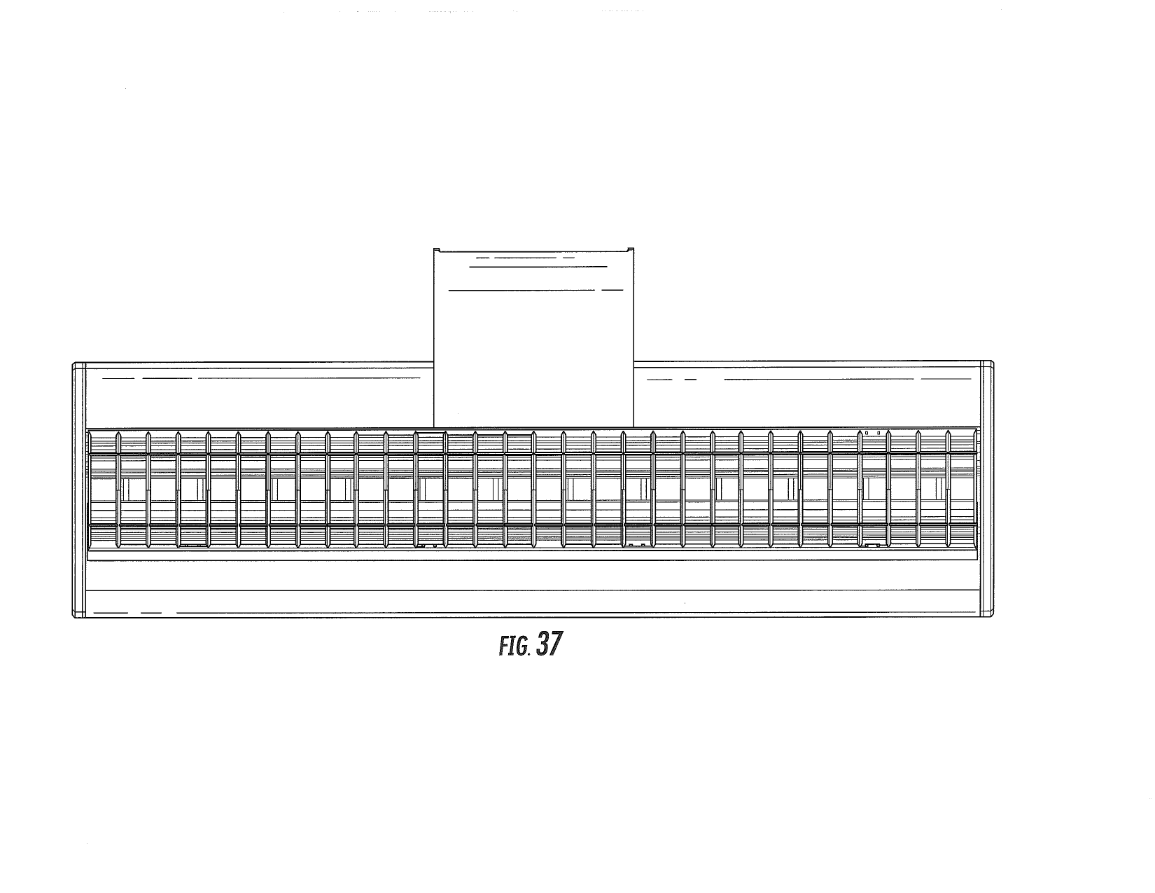

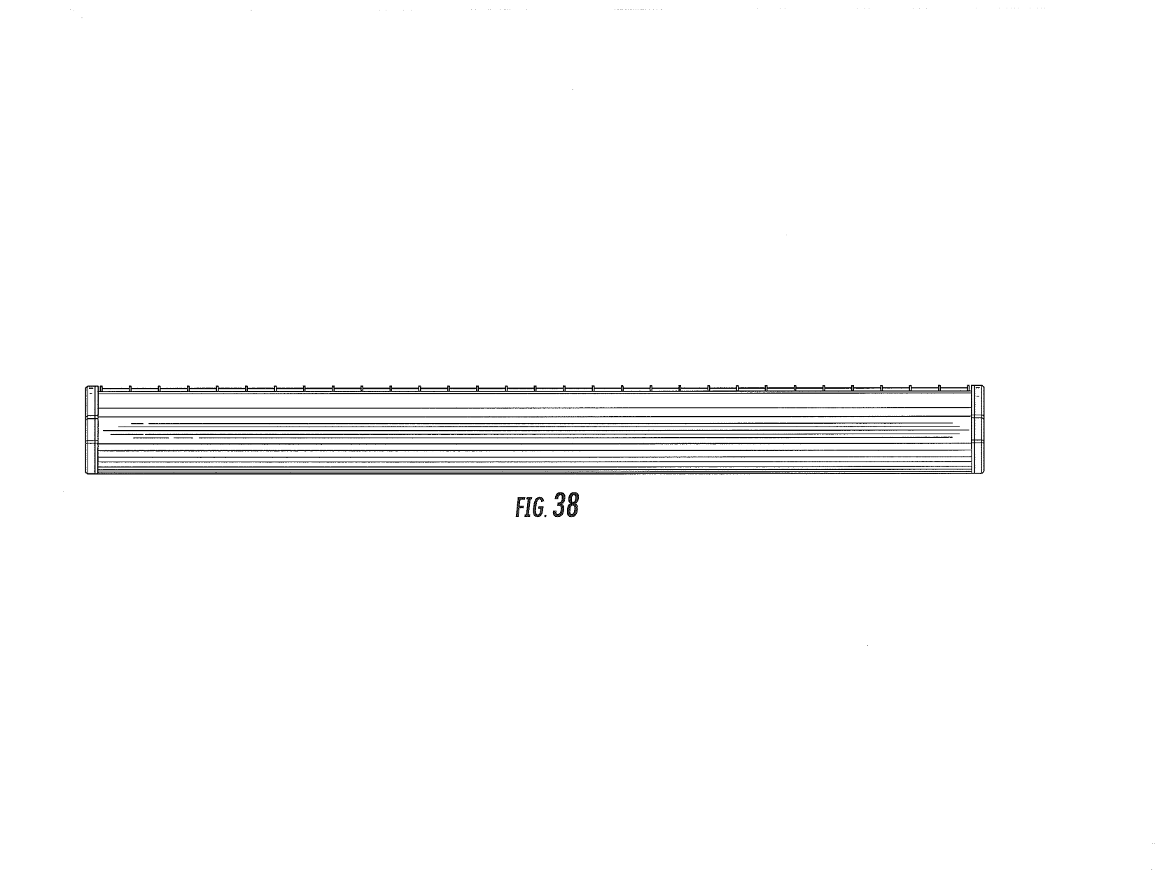

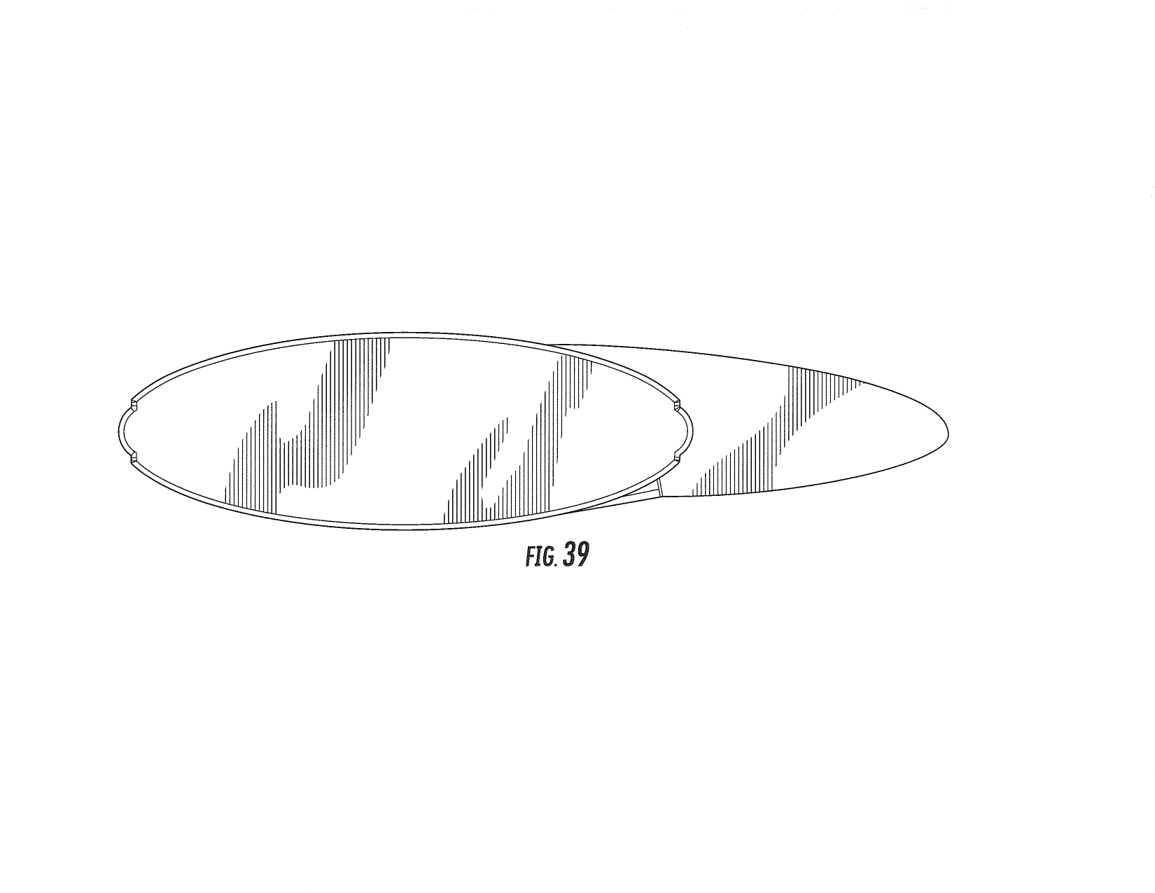

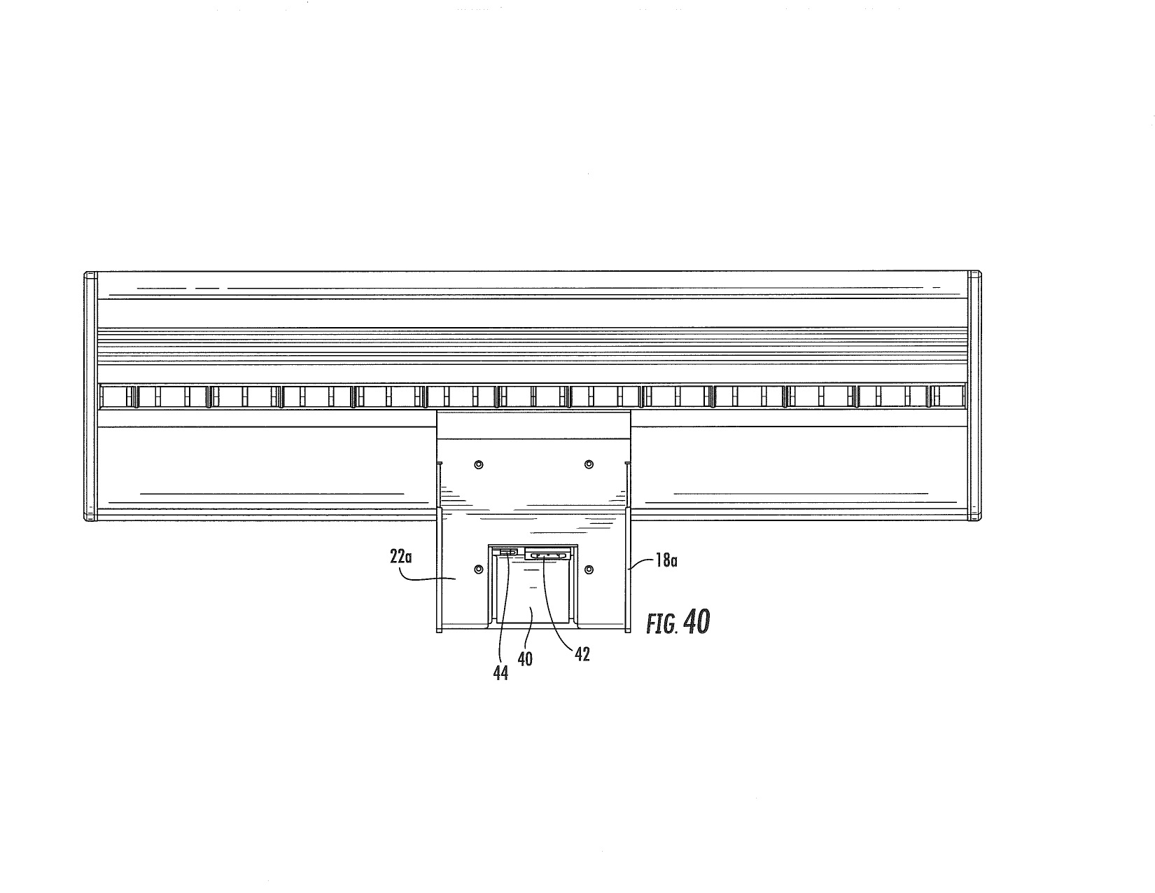

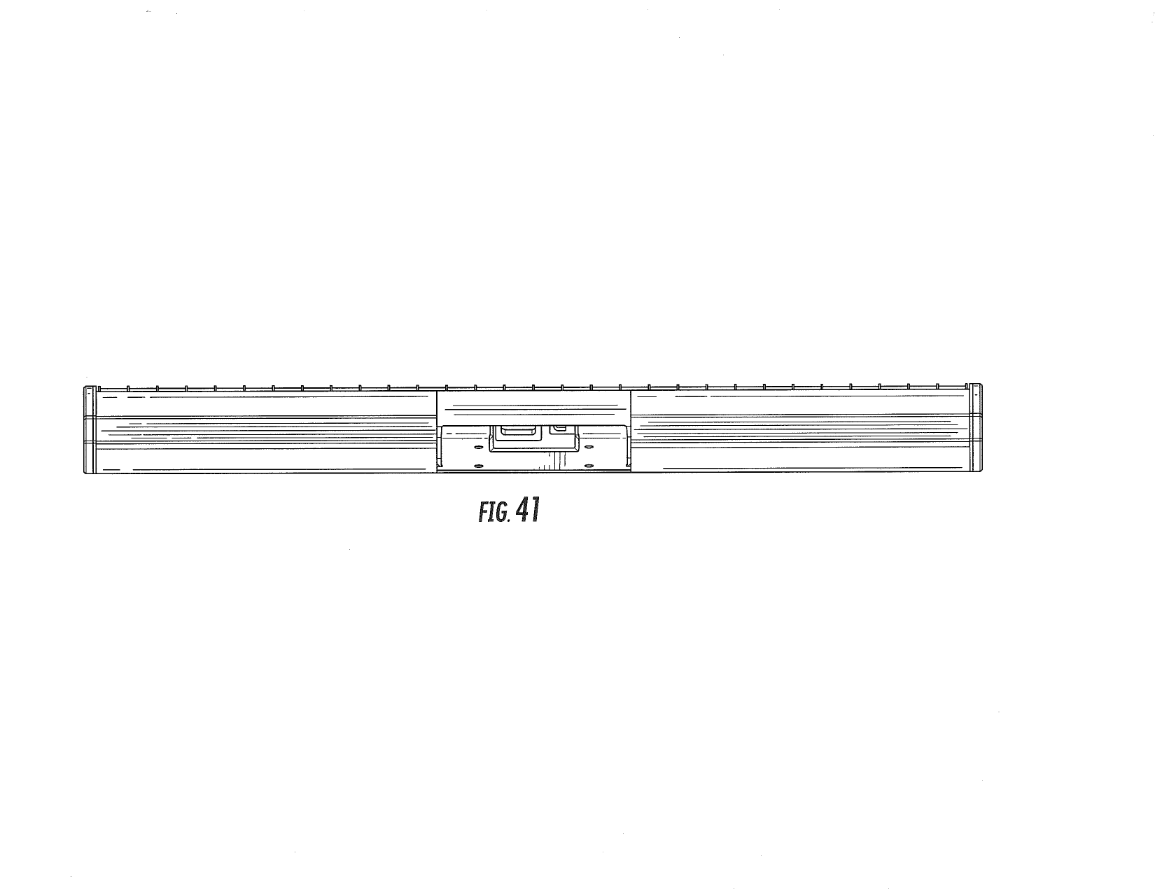

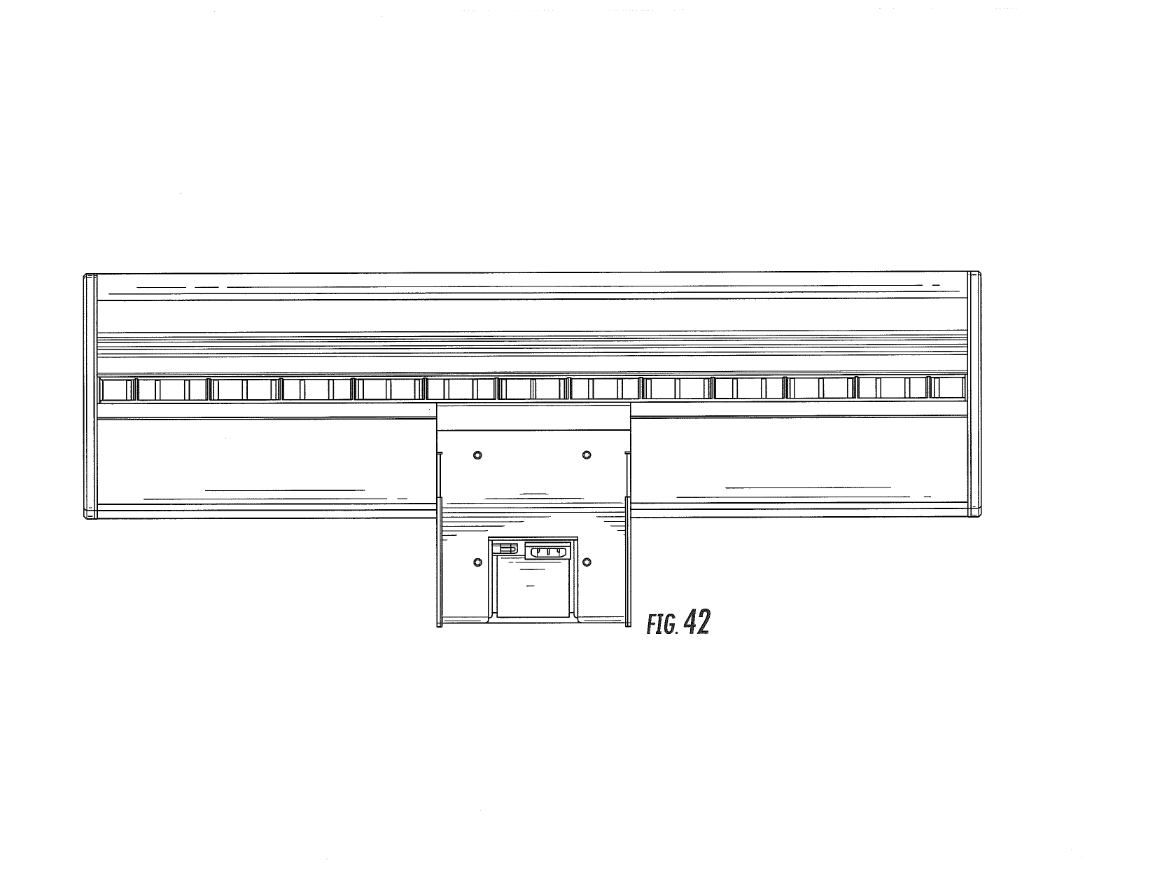

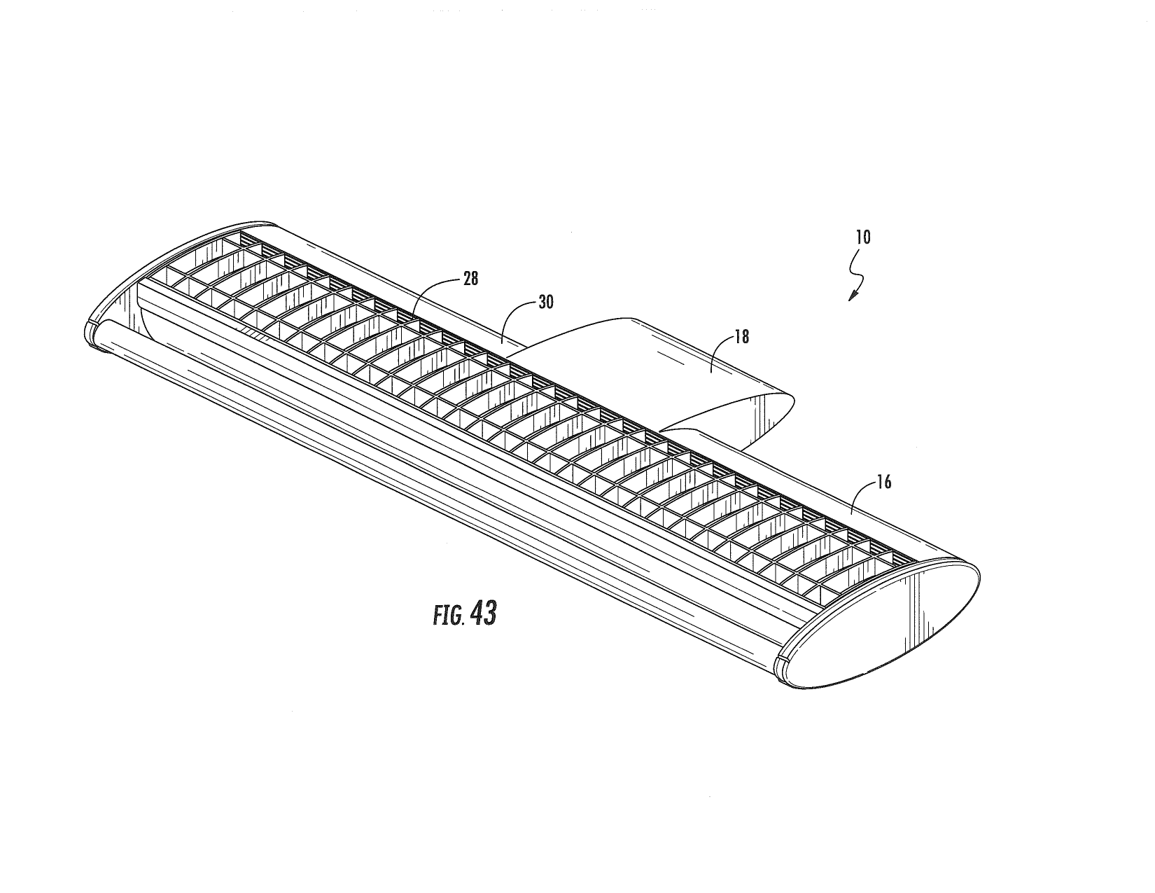

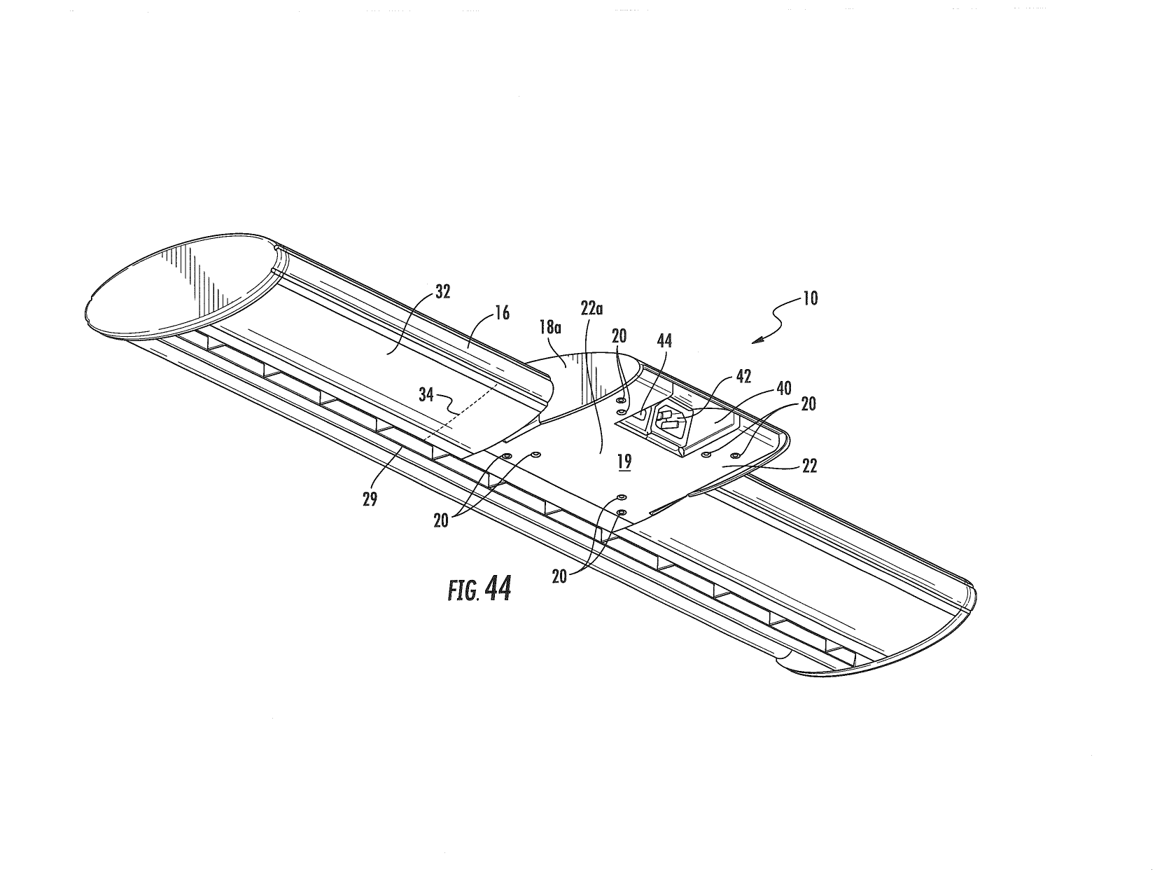

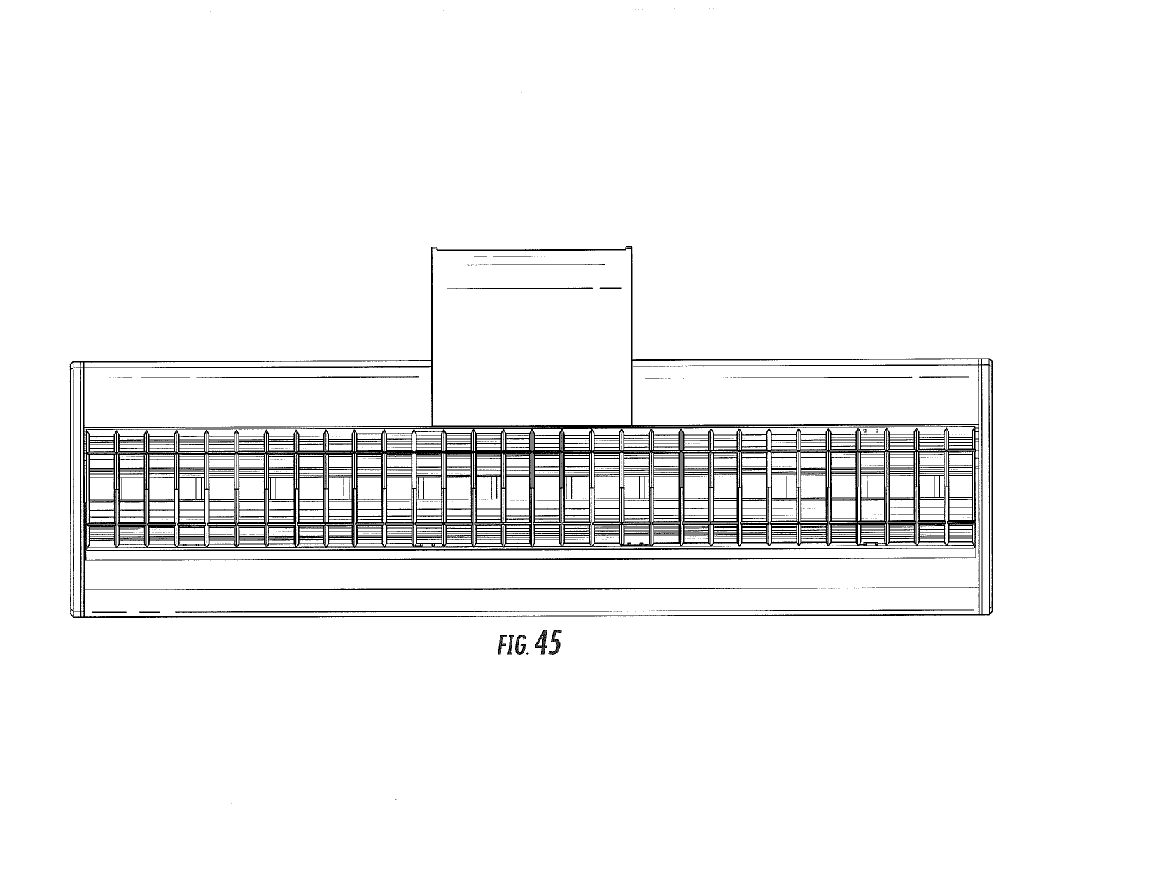

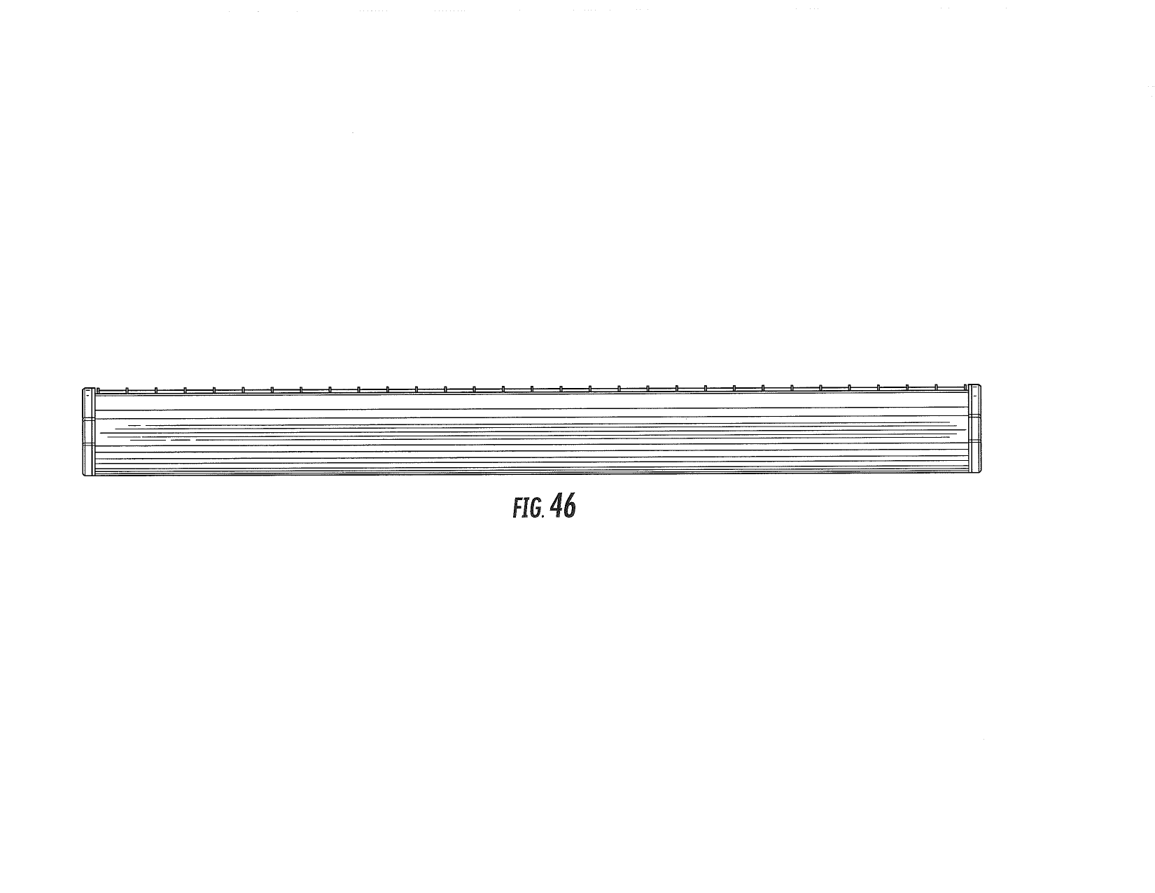

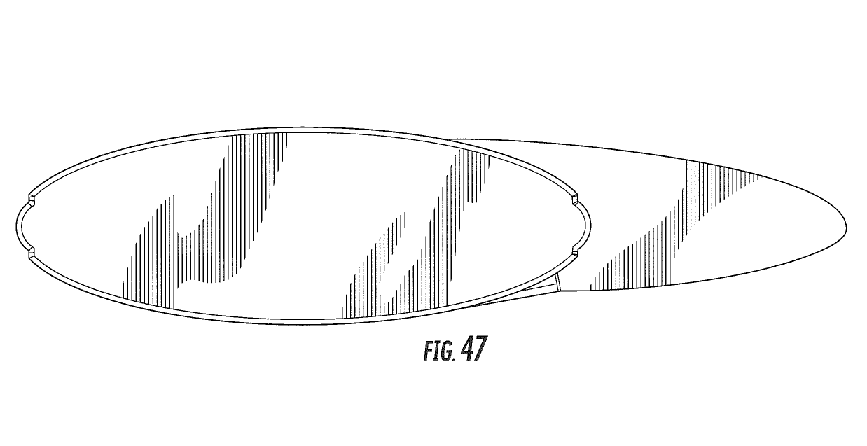

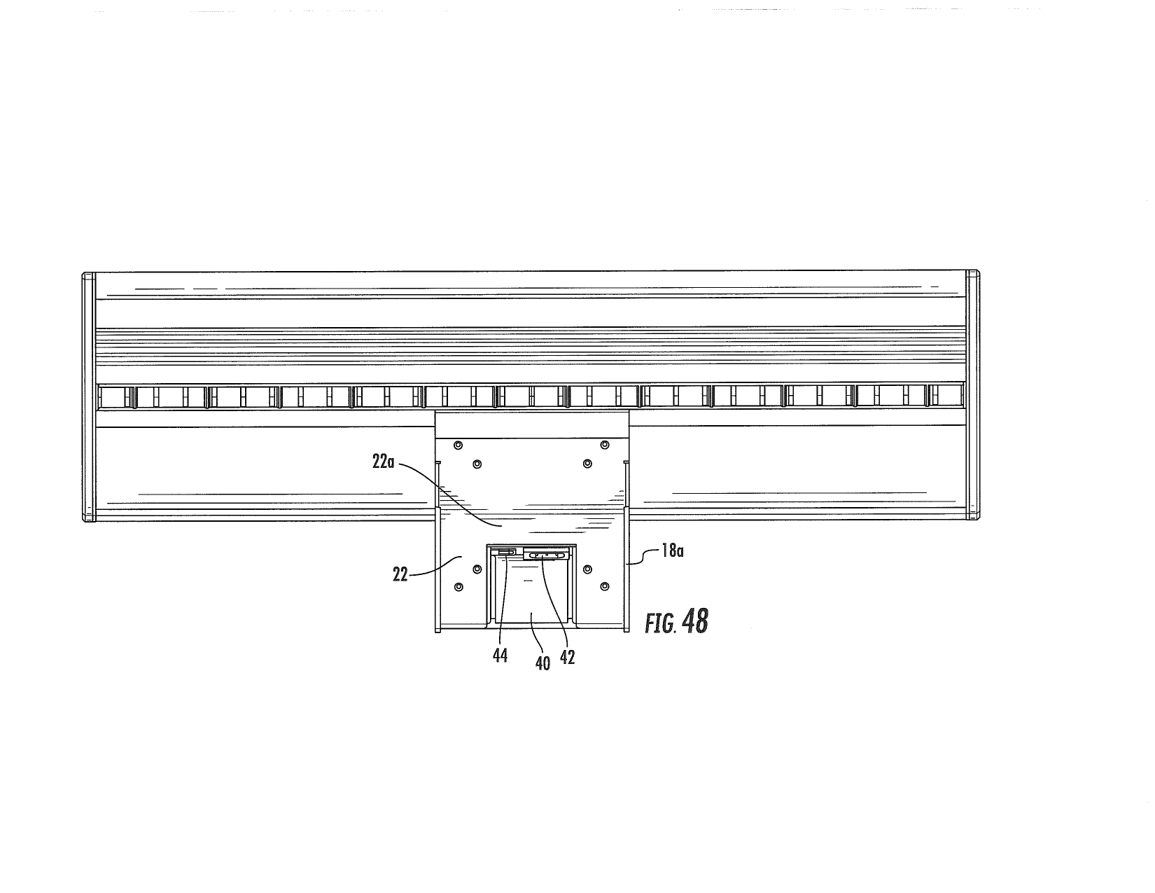

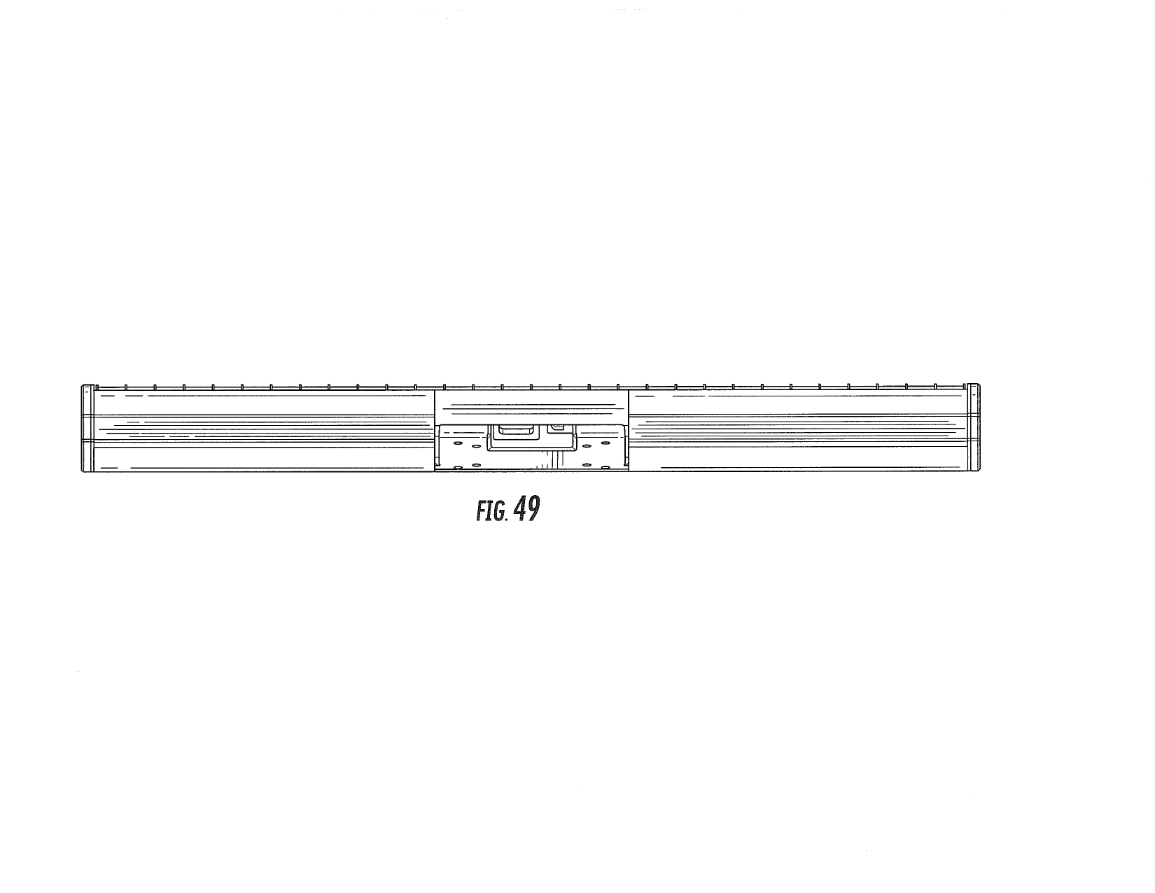

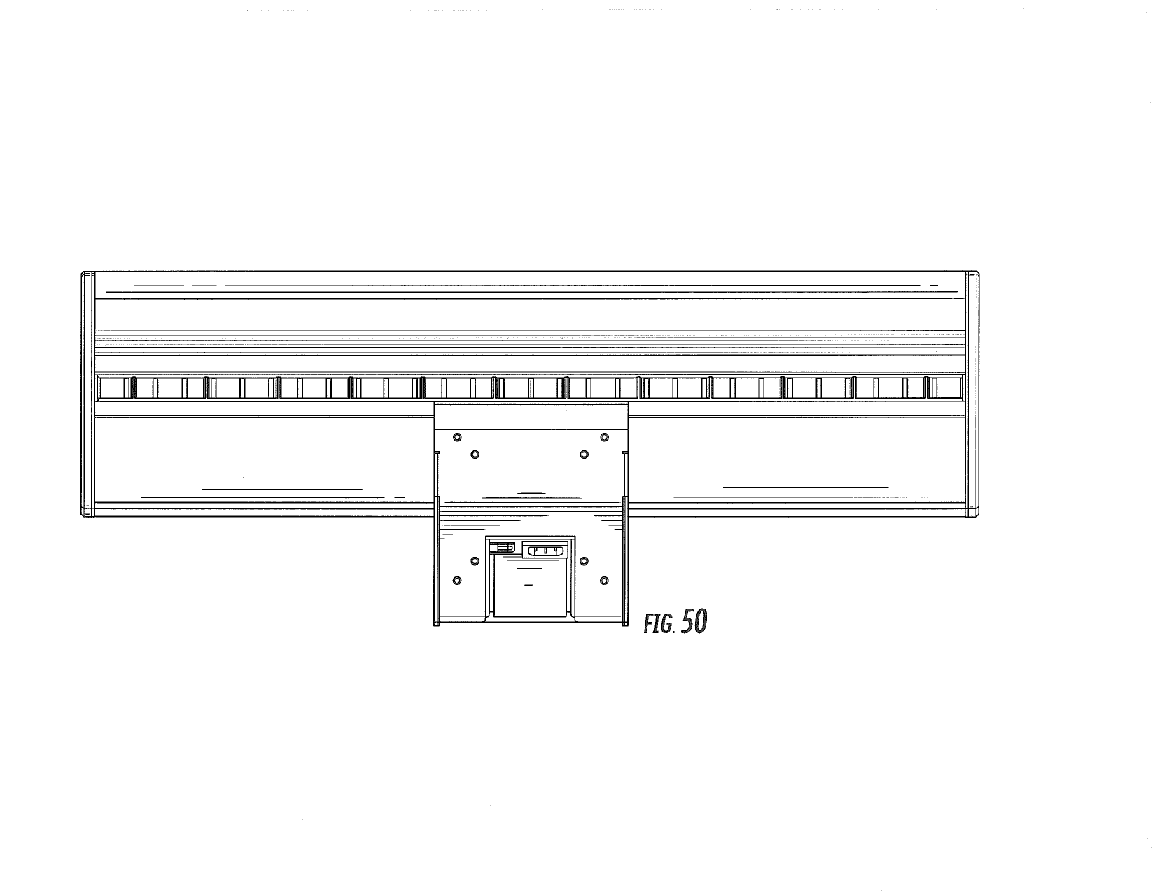

Turning now to FIGS. 27- 34, FIGS. 35-42, and FIGS. 43-50 respectively, exemplary embodiments are shown that differ from the embodiment of FIGS. 1-10, FIGS. 11-18, and FIGS. 19-26 via presence of access region 40 in the mounting interface 18a and interface surface 19a. That is, the embodiments shown in FIGS. 27-34, FIGS. 35-42, and FIGS. 43-50 include the same opening arrangement (separated by the same distances) as that which is shown in FIGS. 1-10, FIGS. 11-18, and FIGS. 19-26 respectively, but also include the access region 40 defined by the body of the interface 18. As shown in FIGS. 27-50, the access region 40 allows access to interface inputs/outputs 42 and 44, which creates increased flexibility of use with different work stations or luminaire supports and power cords used in conjunction with other electrical workstation resources such as VDT's. In the exemplary embodiments shown in the Figures, these inputs/outputs 42 are electrical power and/or control signal connectors disposed integrally with the interface 18, such as but not limited to a C14 appliance cord connector(s).

Referring back to FIG. 4, such a luminaire support 46 is shown in the luminaire mounting system 14. The luminaire support includes a support interface 50 that is compatible with the interface surfaces 19 and/or 19a and association points/openings 20 in the square patterns 22 and/or 22a of any of the above discussed embodiments. That is, the support interface 50 includes support association points or openings 52 that are separated from each other by the same distance discussed as the points/openings of the square patterns 22 and/or 22a of any of the above discussed embodiments. Like the association points/openings 20 of the interface surface 19, the support points 52 shown in the exemplary embodiment of FIG. 4 are all threaded openings that may be configured to accept an M4 machine screw fastener. However, male threaded instruments or snap fit extensions may also be used hereagain.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. A luminaire mounting interface comprising:
an interface body configured for association with a luminaire; and
an interface surface of said interface body, said interface surface including at least two association points separated by 75 mm to 142 mm.

2. The luminaire mounting interface of claim 1, wherein said at least two association points are four association points arranged at corners of a substantially square pattern, said points arranged at said corners being separated at an equidistant width dimension and length dimension of 75 mm to 100 mm, and a diagonal dimension of 106 mm to 142 mm.

3. The luminaire mounting interface of claim 1, wherein said interface body is removably affixable to the luminaire.

4. The luminaire mounting interface of claim 1, wherein said interface body is retrofittable with an existing luminaire.

5. The luminaire mounting interface of claim 1, wherein said interface body is integrally constructed with the luminaire.

6. The luminaire mounting interface of claim 1, wherein the interface surface extends from the luminaire and at least partially overlaps with a housing of the luminaire.

7. The luminaire mounting interface of claim 6, wherein the interface surface at least partially overlaps with a housing of the luminaire in a non-vertical direction, and at least one of said at least two association points is disposed in an area of said mounting surface that overlaps with the housing of the luminaire.

8. The luminaire mounting interface of claim 1, wherein said at least two association points are threaded openings.

9. The luminaire mounting interface of claim 1, wherein said at least two association points are eight association points arranged at corners of a first substantially square pattern and a second substantially square pattern, said points arranged at said corners of said first substantially square pattern being separated at an equidistant width dimension and length dimension of 100 mm, and a diagonal dimension of 141.42 mm, and said points arranged at said corners of said second substantially square pattern being separated at an equidistant width dimension and length dimension of 75 mm, and a diagonal dimension of 106.07 mm.

10. The luminaire mounting interface of claim 1, wherein said interface body includes at least one accessible electrical power connector associated with said interface body.

11. A luminaire comprising:
a luminaire housing;
an interface body extending from said luminaire housing; and
an interface surface of said interface body, said interface surface including at least two association points separated by 75 mm to 142 mm.

12. The luminaire of claim 11, wherein said at least two association points are four association points arranged at corners of a substantially square pattern, said points arranged at said corners being separated at an equidistant width dimension and length dimension of 75 mm to 100 mm, and a diagonal dimension of 106 mm to 142 mm.

13. The luminaire of claim 11, wherein the interface surface at least partially overlaps with said luminaire housing.

14. The luminaire of claim 13, wherein the interface surface at least partially overlaps with a housing of the luminaire in a non-vertical direction and at least one of said at least two association points is disposed in an area of said mounting surface that overlaps with said luminaire housing.

15. The luminaire of claim 11, wherein said at least two association points are threaded openings.

16. The luminaire of claim 11, wherein the luminaire is a task ambient luminaire that includes an uplight aperture and downlight aperture, and wherein a width of a non-aperture surface disposed at a relative top of said luminaire housing and a width of a non-aperture surface disposed at a relative bottom of said luminaire housing is less than 141 mm.

17. The luminaire of claim 16, wherein said width of said non-aperture surface disposed at said relative top of said luminaire housing and said width of said non-aperture surface disposed at said relative bottom of said luminaire housing is less than 75 mm.

18. The luminaire of claim 11, wherein said at least two association points are eight association points arranged at corners of a first substantially square pattern and a second substantially square pattern, said points arranged at said corners of said first substantially square pattern being separated at an equidistant width dimension and length dimension of 100 mm, and a diagonal dimension of 141.42 mm, and said points arranged at said corners of said second substantially square pattern being separated at an equidistant width dimension and length dimension of 75 mm, and a diagonal dimension of 106.07 mm.

19. The luminaire of claim 11, wherein said interface body includes at least one accessible electrical power connector associated with said interface body.

20. A luminaire mounting system comprising:
a luminaire with a luminaire housing;
an interface body extending from said luminaire housing;
an interface surface of said interface body, said interface surface including at least two association points separated by 75 mm to 142 mm; and
a luminaire support including a support interface that is compatible with said interface and said at least two association points.

21. The luminaire mounting system of claim 20, wherein said at least two association points are four association points arranged at corners of a substantially square pattern, said points arranged at said corners being separated at an equidistant width dimension and length dimension of 75 mm to 100 mm, and a diagonal dimension of 106 mm to 142 mm.

22. The luminaire mounting system of claim 20, wherein the interface surface at least partially overlaps with said luminaire housing.

23. The luminaire mounting system of claim 20, wherein the interface surface at least partially overlaps with a housing of the luminaire in a non-vertical direction, and at least one of said at least two association points is disposed in an area of said mounting surface that overlaps with said luminaire housing.

24. The luminaire mounting system of claim 20, wherein said at least two association points are threaded openings.

25. The luminaire mounting system of claim 20, wherein the luminaire is a task ambient luminaire that includes an uplight aperture and downlight aperture, and wherein a width of a non-aperture surface disposed at a relative top of said luminaire housing and a width of a non-aperture surface disposed at a relative bottom of said luminaire housing is less than 141 mm.

26. The luminaire mounting system of claim 25, wherein said width of said non-aperture surface disposed at said relative top of said luminaire housing and said width of said non-aperture surface disposed at said relative bottom of said luminaire housing is less than 75 mm.

27. The luminaire mounting system of claim 20, wherein said at least two association points are eight association points arranged at corners of a first substantially square pattern and a second substantially square pattern, said points arranged at said corners of said first substantially square pattern being separated at an equidistant width dimension and length dimension of 100 mm, and a diagonal dimension of 141.42 mm, and said points arranged at said corners of said second substantially square pattern being separated at an equidistant width dimension and length dimension of 75 mm, and a diagonal dimension of 106.07 mm.

28. The luminaire mounting system of claim 20, wherein said interface body includes at least one accessible electrical power connector associated with said interface body.
